(19) United States
(12) Patent Application Publication
(10) Pub. No.: US 2025/0187528 A1
(43) Pub. Date: Jun. 12, 2025

(54) DUAL MODE CARGO RESTRAINT

(71) Applicant: MBull Holdings, LLC, North Miami Beach, FL (US)

(72) Inventor: Matthew Bullock, McLean, VA (US)

(21) Appl. No.: 18/533,578

(22) Filed: Dec. 8, 2023

(51) Int. Cl. B60P 7/14; B65D 88/12; B65D 90/00

(52) U.S. Cl. CPC B60P 7/14; B65D 88/121; B65D 90/0066

(57) ABSTRACT

A corrugated, foldable, cargo restraint panel may be placed adjacent to a stack of cargo units in a cargo container. The cargo restraint panel may comprise an extruded base panel formed from a polymer material with the base panel comprising a first sheet integrally joined to a second sheet by corrugation flutes forming a unitary, integral structure of the base panel. Tails of the load restraint strips may be wrapped around the cargo restraint panel, tensioned, and secured together. The wrapped load restraint strip tails may be tensioned using a tensioning tool or using elastic strips, and the wrapped and tensioned tails may be secured together.

### BACKGROUND

When transporting cargo in a truck or other type of cargo container, the cargo should be secured to prevent shifting and/or damage. If the cargo comprises numerous discrete cargo units that are relatively small and/or lightweight (e.g., cardboard boxes), and that may vary in size and quantity, securing that cargo may present additional challenges.

### SUMMARY

This Summary is provided to introduce a selection of some concepts in a simplified form as a prelude to the Detailed Description. This Summary is not intended to identify key or essential features.

Described herein are systems and methods for securing cargo units in a cargo container using load restraint strips and cargo restraint panels. Attachment regions of load restraint strips may be affixed to interior walls of a cargo container. Cargo units may be stacked in the container, and a corrugated cargo restraint panel may be placed adjacent to that stack. Tails of the load restraint strips may be wrapped around the cargo restraint panel, tensioned, and secured together. The wrapped load restraint strip tails may be tensioned using a tensioning tool or using elastic strips, and the wrapped and tensioned tails may be secured together.

These and other features are described in more detail below.

### BRIEF DESCRIPTION OF THE DRAWINGS

Some features are shown by way of example, and not by way of limitation, in the figures of the accompanying drawings and in which like reference numerals refer to similar elements.

FIGS. 1A-1D show various views of an example restraint panel that may be used with a cargo container.

FIGS. 2A-2C show a side view and enlarged side views of the cargo restraint panel from FIGS. 1A-1D.

FIGS. 3A-3D show an example corner edge guard from the cargo restraint panel from FIGS. 1A-1D.

FIGS. 4A-4E show an example side edge guard from the cargo restraint panel from FIGS. 1A-1D.

FIG. 5 shows another example cargo restraint panel that may be used with a cargo container.

FIG. 6 shows another view of the cargo restraint panel from FIG. 5 with an enlarged view of the cross-section of the cargo restraint panel.

FIGS. 7A-7H show portions of the example cargo restraint panel from either FIGS. 1A-1D or FIG. 5 with various exemplary cross-sections for the cargo restraint panel.

FIGS. 8A-8C show an example pallet clip and pallet block for use with the cargo restraint panel from either FIGS. 1A-1D or FIG. 5.

FIGS. 9A-9H show an example cargo container during various stages of an example method for dual mode cargo restraint.

FIG. 10 shows an example of additional dual mode cargo restraint.

FIG. 11 shows an example of dual mode cargo restraint in which tails of load restraint strips are tensioned using elastic strips.

FIG. 12A shows an enlarged view of features shown in a portion of FIG. 11.

FIG. 12B shows an enlarged view, similar to that of FIG. 12A, after addition of a connecting patch.

FIG. 13 shows another example of dual mode cargo restraint in which tails of load restraint strips are tensioned using elastic strips.

FIG. 14A shows an enlarged view of features shown in a portion of FIG. 13.

FIG. 14B shows an enlarged view, similar to that of FIG. 14A, after addition of a connecting patch.

FIG. 15 is a block diagram showing steps of an example method for dual mode cargo restraint.

FIG. 16 shows another example of dual mode cargo restraint.

### DETAILED DESCRIPTION

Securing a cargo load comprising numerous discrete cargo units of varying sizes presents various challenges, particularly if some or all of those cargo units are relatively small in size (e.g., 4 cubic feet (cu. ft.) or less) and/or relatively lightweight (e.g., less than 25 pounds). These challenges may be more acute if the cargo units are not palletized or otherwise secured to one another. For example, a semi truck or other cargo container may be loaded with numerous cardboard boxes or other cargo units that are stacked on top of one another, and that rest directly on a floor of the cargo container. Known solutions for securing such loads may rely on movable partitions that may be expensive and/or heavy, that may require customized brackets or other hardware to secure in place, and/or that may have other disadvantages.

Some or all of these disadvantages may be addressed using dual mode cargo restraint systems and methods such as are described herein. Such dual mode cargo restraint systems may comprise lightweight, extruded, and reusable cargo restraint panels having a corrugated core, as well as load restraint strips. The cargo restraint panel may be placed adjacent to (e.g., against and/or in contact with) a face of a cargo unit stack. Adhesive portions of the load restraint strips may be attached to interior walls of the cargo container, and tails of the load restraint strips wrapped around the placed cargo restraint panel and secured together. Once the tails are secured to one another, the cargo restraint panel is secured in place. The rigid and lightweight nature of the cargo restraint panel, combined with the adaptable tension applied to the load restraint strip tails, allows those panels to be easily pressed against the cargo unit stack with relatively modest pressure. This results in a bulkhead that securely holds the cargo units in place without unduly compressing, crushing or otherwise damaging the cargo units.

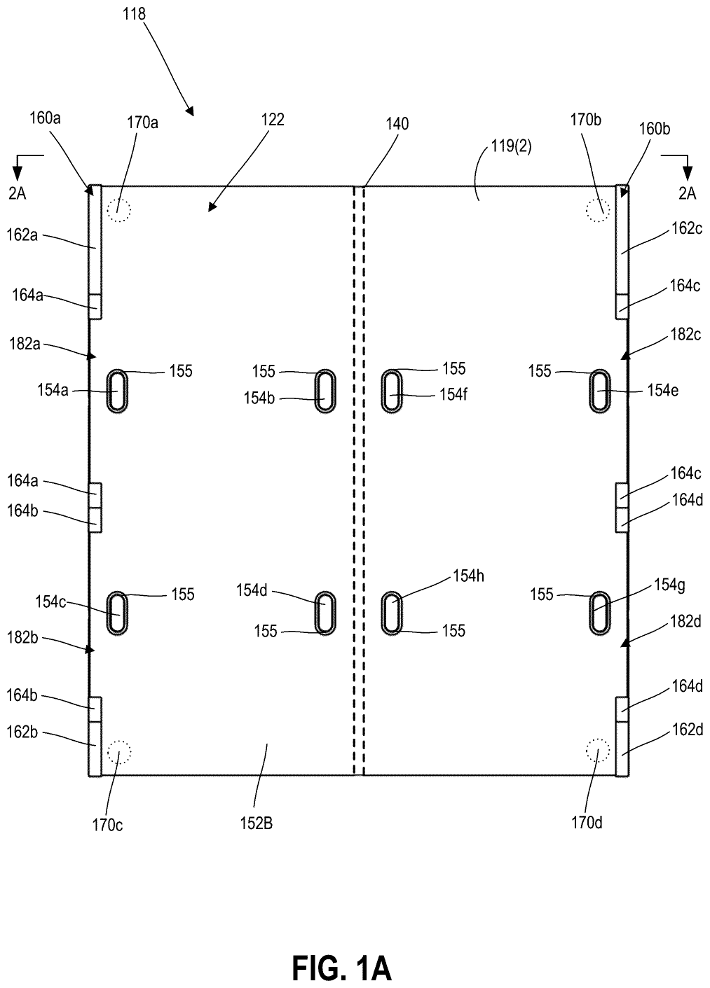

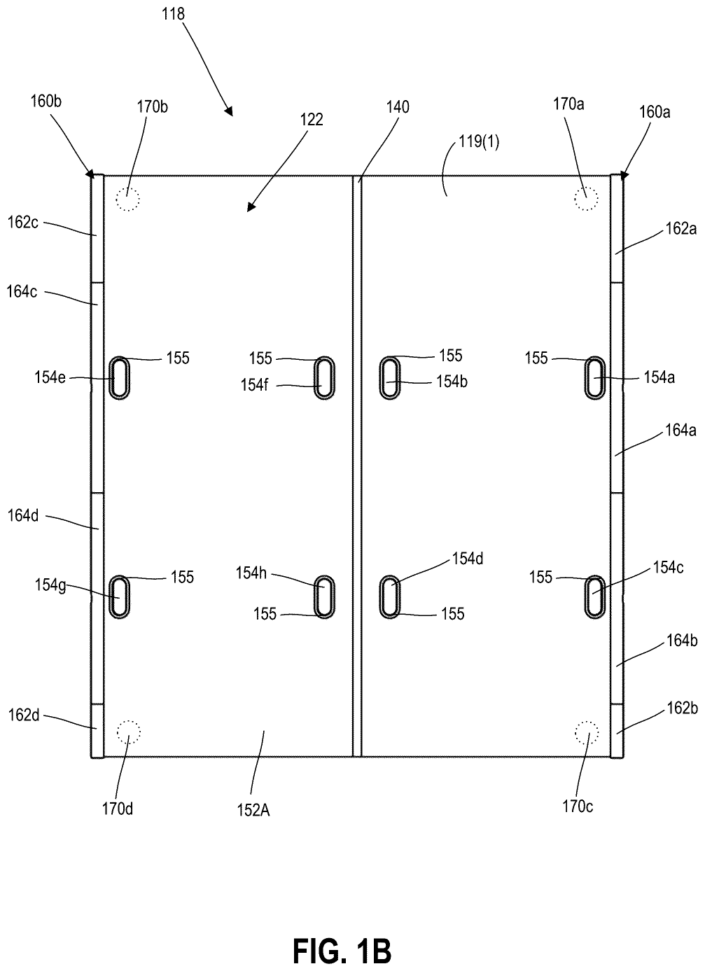

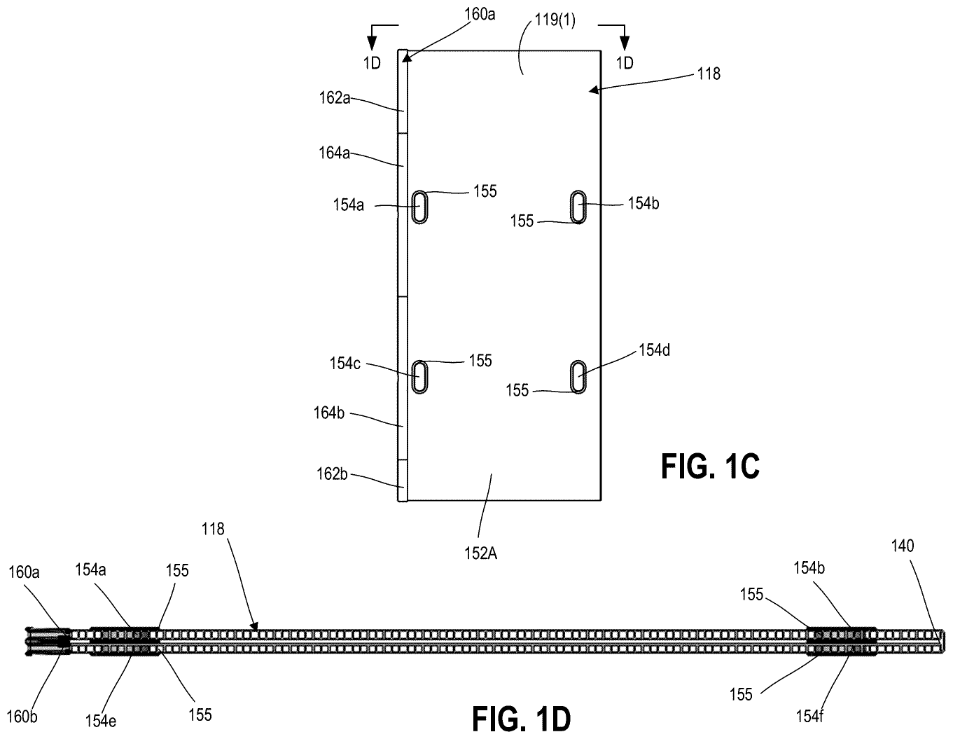

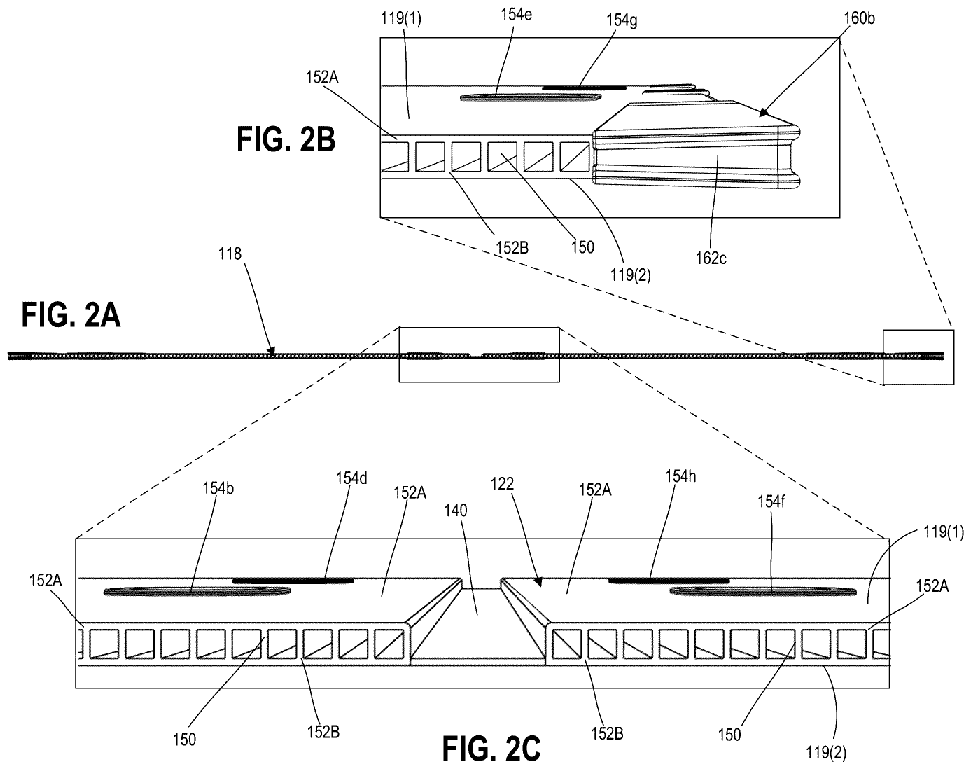

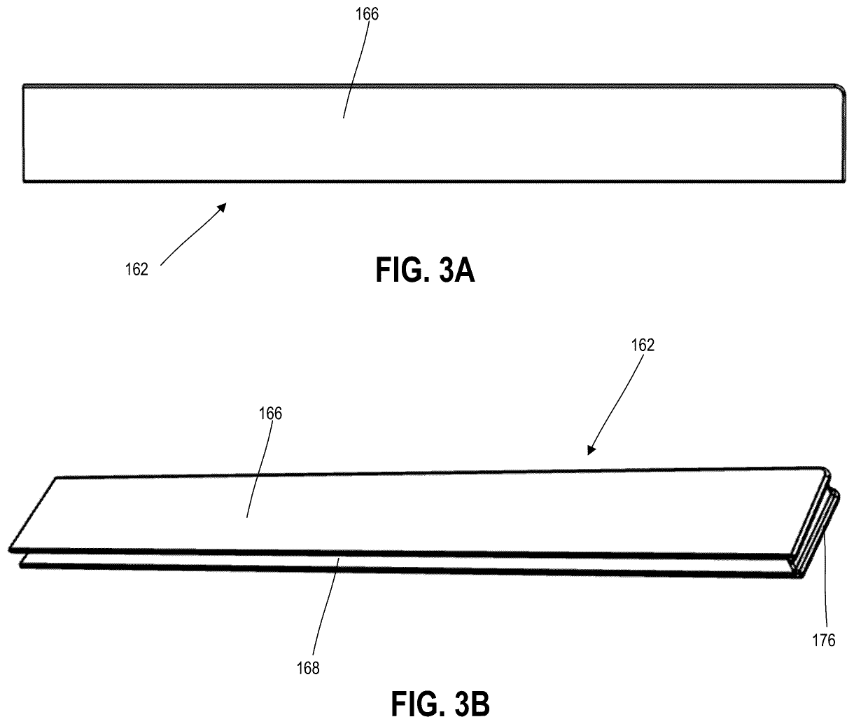

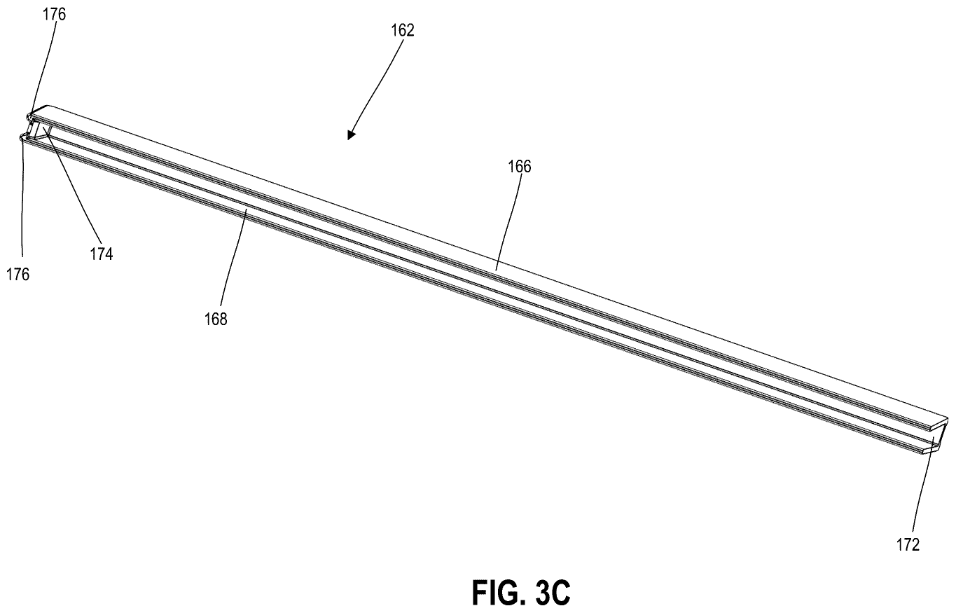

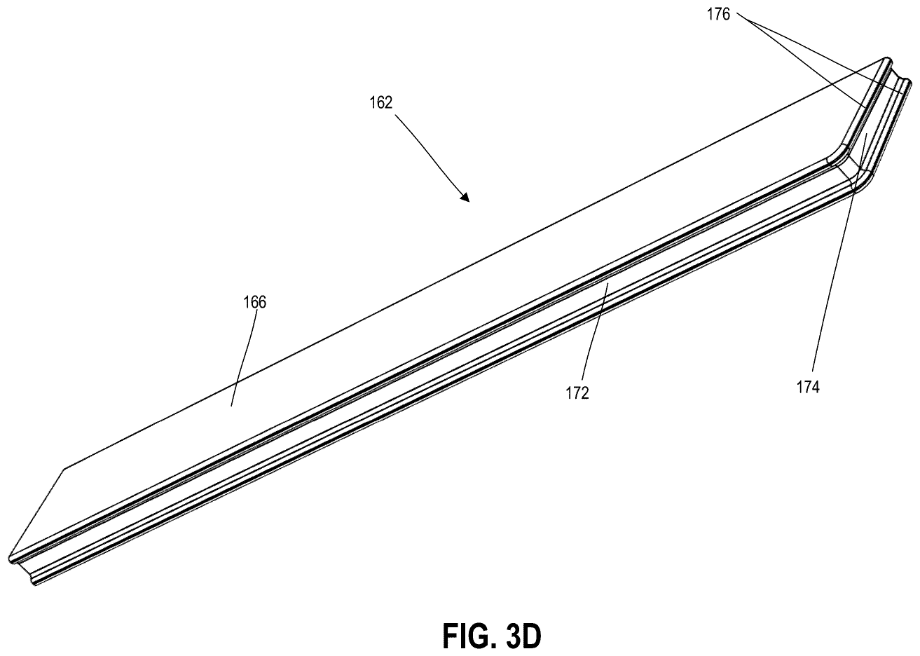

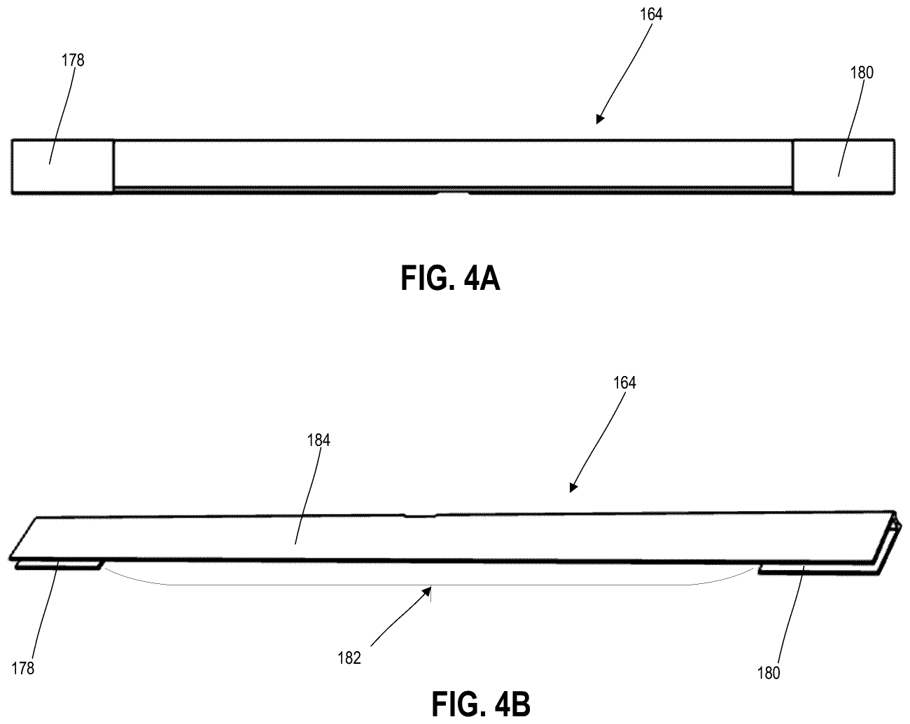

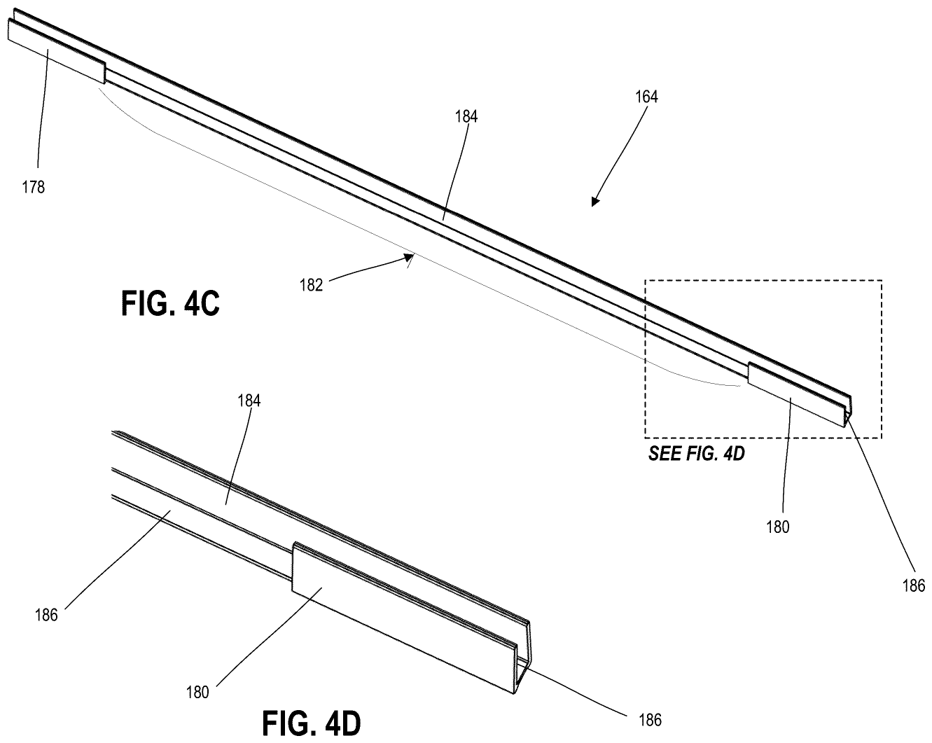

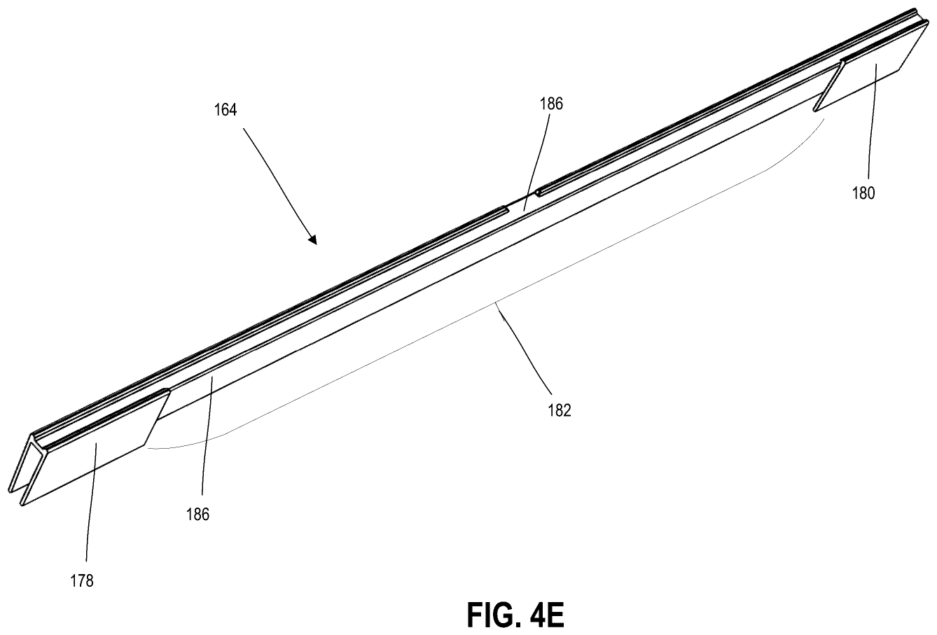

FIGS. 1A-4C show an example cargo restraint panel 118 and/or portions of the cargo restraint panel 118 that may be used with a cargo container 100. FIG. 1A shows a back view of the cargo restraint panel 118 in the open configuration and FIG. 1B shows a front view of the cargo restraint panel 118 in the open configuration. FIGS. 1C and 1D show the cargo restraint panel 118 in the closed or folded configuration. FIG. 2A shows a side view, from a top edge as indicated in FIG. 1A, of the cargo restraint panel 118 with FIGS. 2B and 2C showing close-up views of portions of the side view of the cargo restraint panel 118 from FIG. 2A. FIGS. 3A-3D show an example corner edge guard from the cargo restraint panel 118. FIGS. 4A-4E show an example side edge guard from the cargo restraint panel 118.

The cargo restraint panel 118 may include an extruded base panel 122. The extruded base panel 122 may include an extruded, polymer corrugated panel that has a first sheet or front sheet 152A integrally joined to a second sheet or back sheet 152B by corrugation flutes 150, with the sheets 152A and 152B and the flutes 150 formed from the same polymer material and forming a unitary, integral structure of the base panel 122. The base panel 122 may comprise the front sheet 152A with a first major surface 119(1) configured to face a stack of cargo units 105, the back sheet 152B with a second major surface 119(2) (which may be the same as or similar to the first major surface) facing away from the stack of cargo units 105, and the corrugation flutes 150 formed between the front sheet 152A and the back sheet 152B.

The base panel 122 (as will be described later) may include one or more of edge guards, handles, or magnets, etc. to further define the cargo restraint panel 118. A fiberboard (not shown in the figures) may be added to the base panel 122 as additional layer(s) attached to one or both of the sheets 152A, 152B of the base panel 122. The flutes 150 may include bi-directional fluting using a rigid lightweight sheet resin, such as polypropylene or acetal or other similar polymer materials. As shown in FIGS. 2A and 2C, the base panel 122 may also include a 2-ply design with a rectangular structure formed by straight connecting flutes 150 that are perpendicular to the two sheets 152A, 152B. Although the flutes 150 extend in a direction perpendicular to the bottom and top edges of the base panel 122, other embodiments may comprise flutes oriented parallel to the bottom and/or top edge and/or having other orientations.

The base panel 122 may be extruded or otherwise formed from, for example, polypropylene (homopolymer or copolymer). Optionally, the material of the base panel 122 may be reinforced (e.g., with glass or silica). The advantages of using polypropylene for the base panel 122 may include “toughness” (resistance to impact damage), and/or low dyne/surface energy (to prevent excessive attachment to adhesive, making any adhesive-backed material easy to remove). In other examples, the base panel 122 may be extruded or otherwise formed from other possible materials that could include, e.g., acrylonitrile butadiene styrene (ABS), polyvinyl chloride PVC), polyethylene terephthalate (PET), high density polyethylene (HDPE), medium density polyethylene (MDPE), low density polyethylene (LDPE), Nylon, or polycarbonate.

One or more surfaces of the base panel 122 may also include a low surface energy textured facing that helps provide for clean removal of any adhesive strips used with the cargo restraint panel 118. The base panel 122 may be approximately 6-12 mm thick for both rigidity and flexural strength. The base panel 122 may be of other thicknesses depending on the cargo, layout, and/or specifics of intended applications of the cargo restraint panel 118 within the cargo container 100. The base panel 122 may provide an excellent strength to weight ratio. The base panel 122 may be manufactured with approximately 1000-3000 grams per square meter (GSM). The specific gravity of the base panel 122 may be less than 1.0.

Additionally, as shown in FIGS. 1A, 1B, 2A, and 2C, the cargo restraint panel 118 may include a center hinge 140 so that the cargo restraint panel 118 can fold in half and flat for storing and/or stacking. The center hinge 140 may provide for one-way folding of the cargo restraint panel 118. The center hinge 140 may be one or two perforated folds. As shown in FIG. 2C, the center hinge 140 may include a region in which the flutes 150 and the sheet 152A are omitted and/or have been removed. The absence of the corrugation flutes 150 and the sheet 152A within the center hinge 140 facilitates the ability to fold the cargo restraint panel 118 from the open configuration (as shown in FIGS. 1A and 1B) to the folded configuration (as shown in FIGS. 1C and 1D). The center hinge 140 may be formed, for example, by machining away a portion of one of the sheets, such as the front sheet 152A and corresponding flutes 150 to leave a portion of the other sheet, such as the back sheet 152B.

Additionally, as shown in FIGS. 1A and 1B, the cargo restraint panel 118 may include one or more magnets or magnetic attraction elements 170 (individually listed as 170a, 170b, 170c, 170d) to assist with the folding of the cargo restraint panel 118. The magnets or magnetic attraction elements 170 may be located at corresponding corners of the cargo restraint panel 118. As illustrated in FIGS. 1A and 1B, the cargo restraint panel 118 may include the center hinge 140, a first primary magnet 170a, and a first magnetic attraction element 170b comprising at least one of a first plate or magnet. The first primary magnet 170a and the first magnetic attraction element 170b may be positioned so that, when the cargo restraint panel 118 is placed into a folded configuration by folding along the center hinge 140, the first primary magnet 170a attracts the first magnetic attraction element 170b to bias the cargo restraint panel 118 in the folded configuration. The cargo restraint panel 118 may include a second primary magnet 170c, and a second magnetic attachment 170d comprising at least one of a second plate or magnet. The magnetic attraction elements 170b, 170d may be another magnet or a ferrous (e.g., iron or steel) plate that will be attracted by the corresponding primary magnet 170a, 170c. Alternatively, or in addition to, the magnets and the magnetic attraction elements 170 may be located within, attached to, and/or embedded within the edge guards 160a-160d.

The cargo restraint panel 118 may also include handle cut-outs 154 (individually listed as 154a, 154c, 154e, 154g) on one or more of the sides of the cargo restraint panel 118. The cargo restraint panel 118 may also include the handle cut-outs 154 (individually listed as 154b, 154d, 154f, 154h) located along the center hinge 140 location. The handle cut-outs 154 may be provided to provide workers with convenient handling locations to assist the movement and installation of the cargo restraint panel 118. The handle cut-outs 154 may be located such that when the cargo restraint panel 118 is in the folded configuration, the handle cut-outs 154 align with each other, thereby still providing a holding location for a user to move and carry the cargo restraint panel 118. For example, in the folded configuration, handle cut-outs 154a and 154e align with each other, handle cut-outs 154b and 154f align with each other, handle cut-outs 154c and 154h align with each other, and handle cut-outs 154d and 154g align with each other.

Each of the handle cut-outs 154 may also include a handle insert 155 that fits within and/or covers edges of the handle cut-outs 154 and provides an ergonomic handle surface to assist with the movement and installation of the cargo restraint panel. The ergonomic handle inserts 155 may be polymer and/or injection molded.

Additionally, the cargo restraint panel 118 may include one or more edge guards 160 that are located along the sides of the base panel 122. The edge guards 160 may extend along the entire side of the base panel 122 and provide protection for the corners and/or the edges of the cargo restraint panel 118. The edge guards 160 may also provide protection to the user by covering possible sharp edges of the base panel 122. The edge guards 160 may be glued onto the base panel 122, with e.g., cross-linked polyurethane adhesive. Optionally, the edge guards 160 may be integrated as part of the cargo restraint panel 118. The edge guards 160 may include one or more corner edge guards 162 (such as four corner edge guards 162a, 162b, 162c, 162d) and one or more side edge guards 164 (such as four side edge guards 164a, 164b, 164c, 164c). For example, the cargo restraint panel 118 may include a first edge guard 160a with a first corner edge guard 162a adjacent to a first side edge guard 164a that is adjacent to a second side edge guard 164b and that is adjacent to a second corner edge guard 162b. The cargo restraint panel 118 may also include a second edge guard 160b with a third corner edge guard 162c adjacent to a third side edge guard 164c that is adjacent to a fourth side edge guard 164d and that is adjacent to a fourth corner edge guard 162d.

FIGS. 3A-3D show an example corner edge guard 162 that may be utilized with the cargo restraint panel 118. The corner edge guard 162, which may correspond to any of the corner edge guards 162a-162d, may include a first portion 166 that covers a portion of one of front sheet 152A or back sheet 152B and a second portion 168 that covers a corresponding portion of the other of the front sheet 152A or the back sheet 152B. The first portion 166 and the second portion 168 may be integrally joined with an edge portion 172 that covers a portion of a side edge of the base panel 122 adjacent to a corner. The corner edge guard 162 may also include a closed portion 174 integrally joined with the first portion 166, the second portion 168, and the edge portion 172.

The corner edge guard 162 may include one or more rails 176 that extend from the exterior of the closed portion 174 or the edge portion 172. The one or more rails 176 may be raised regions on the exterior to provide a glide surface and/or reduced friction when sliding the cargo restraint panel 118 on the edge across a floor or other surface. When the corner edge guards 162 are installed on the base panel 122, the rails 176 may extend lower than the bottom edge of the base panel 122 (or lower than the top edge, if the cargo restraint panel is upside down) and thereby form the support surfaces for the cargo restraint panel 118. Because there is less surface area on the rails 176 than the entire bottom (or top) edge of the base panel 122, there is less friction when sliding and moving the cargo restraint panel 118 along the floor or surface.

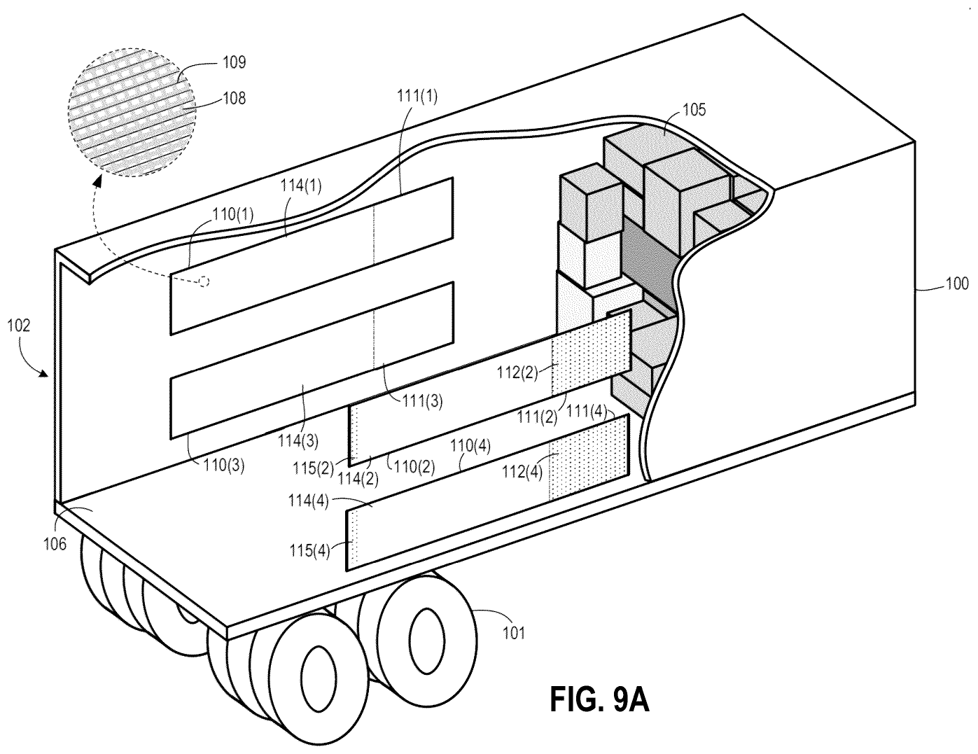

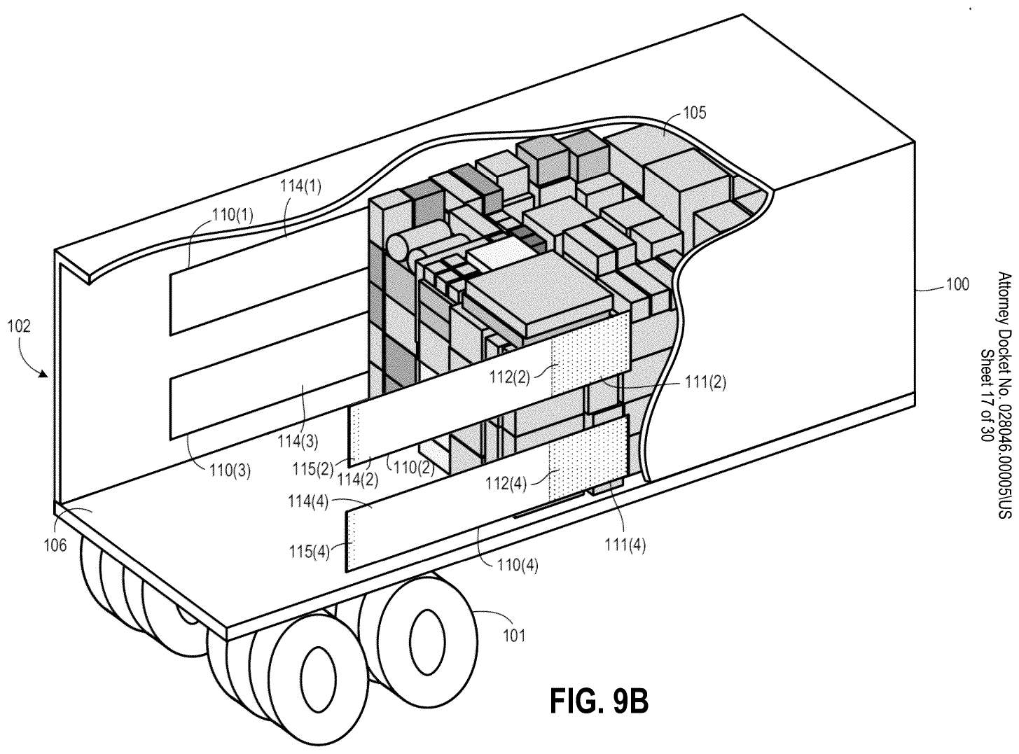

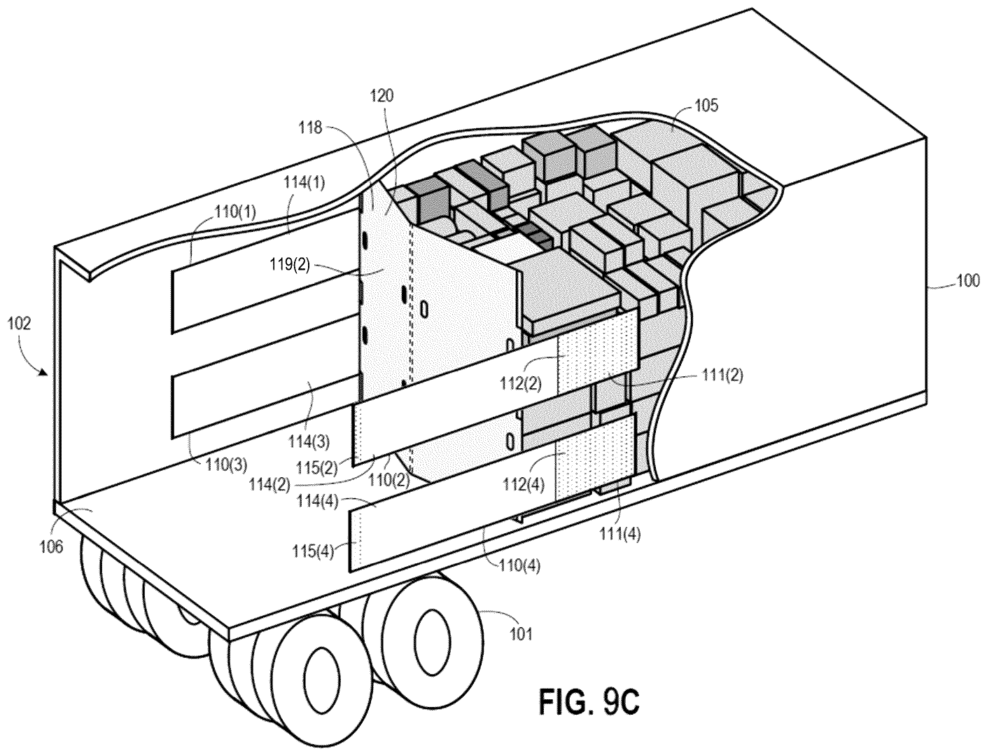

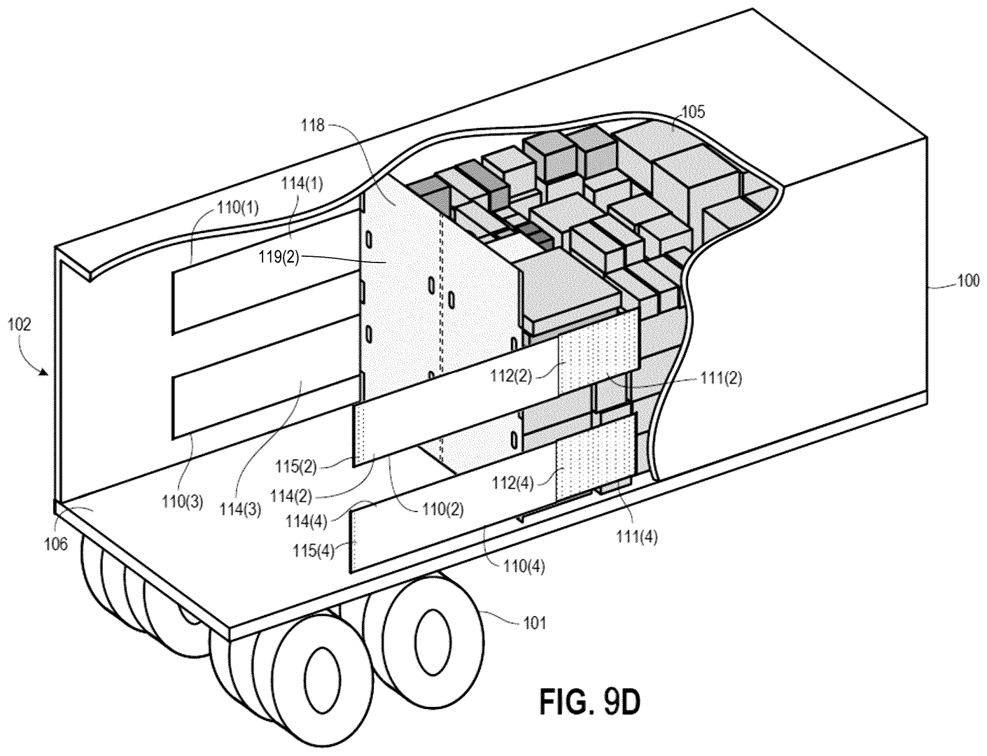

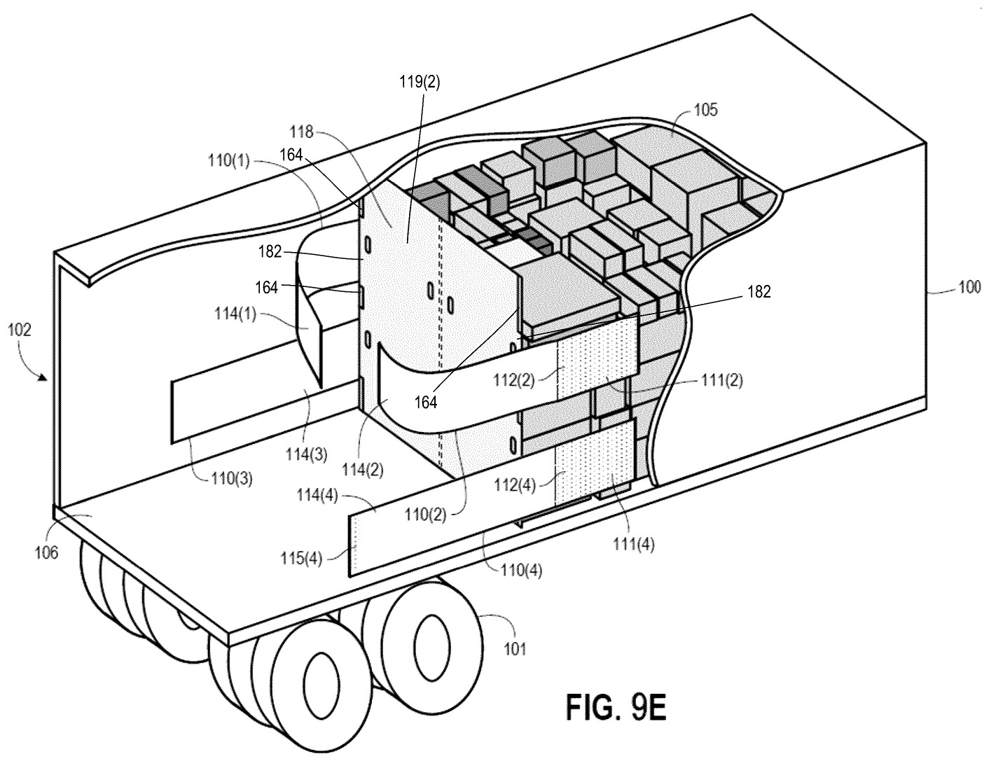

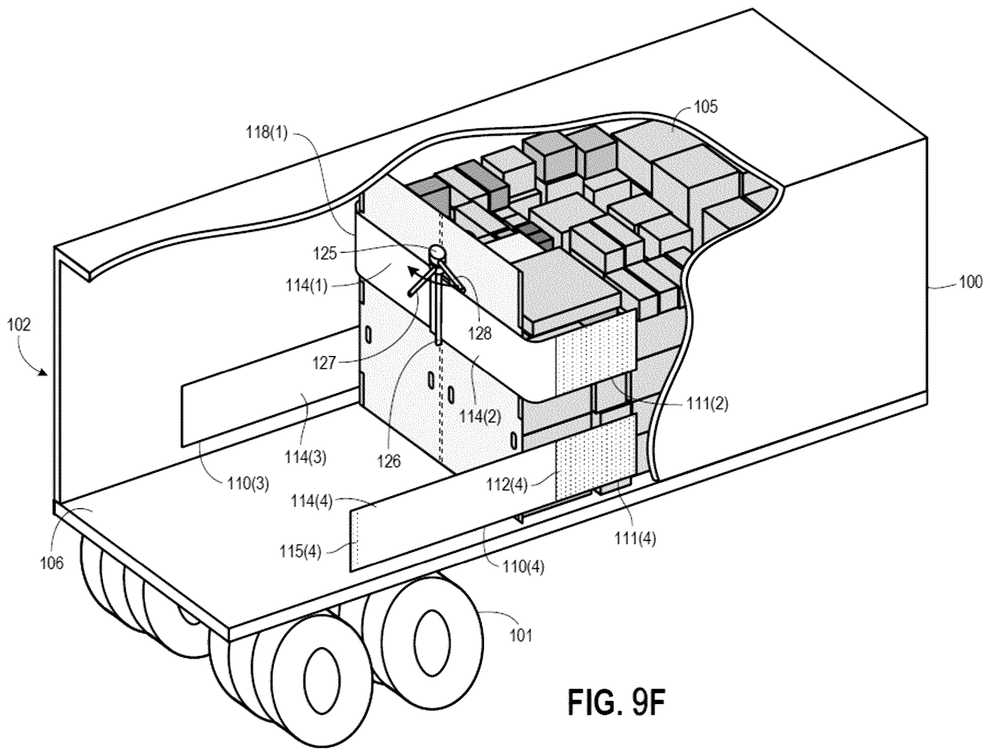

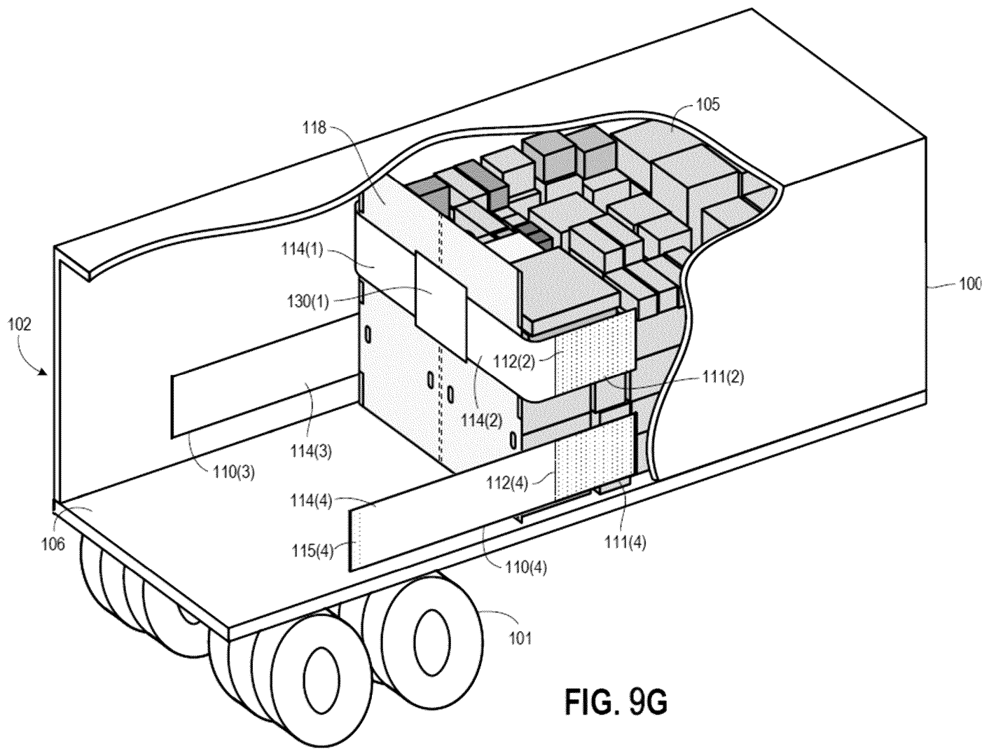

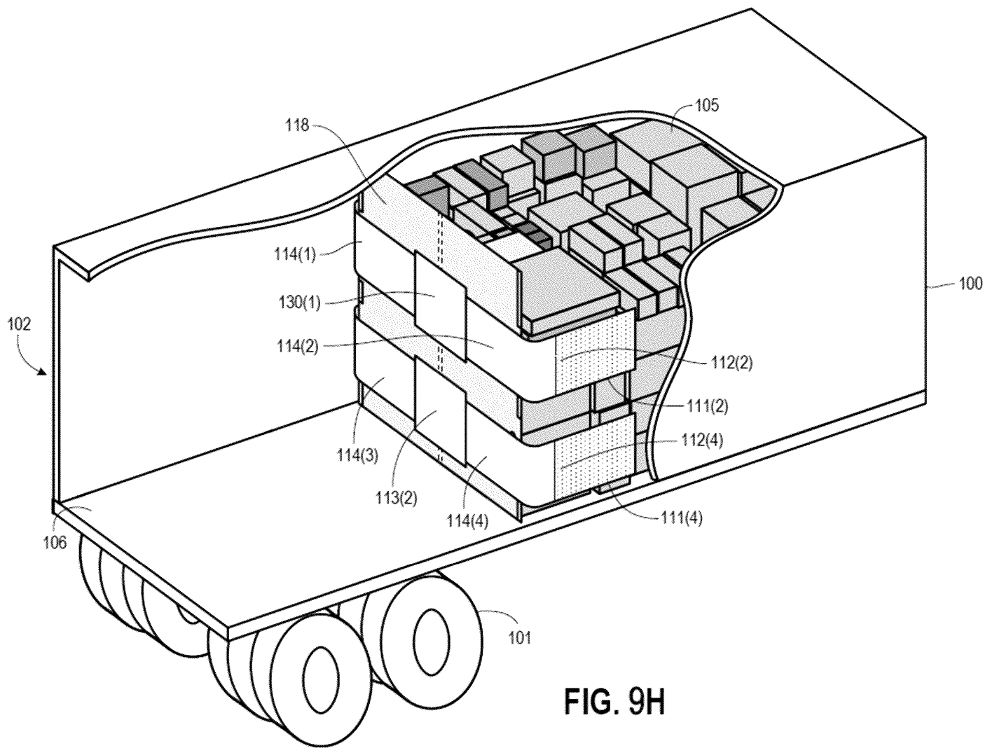

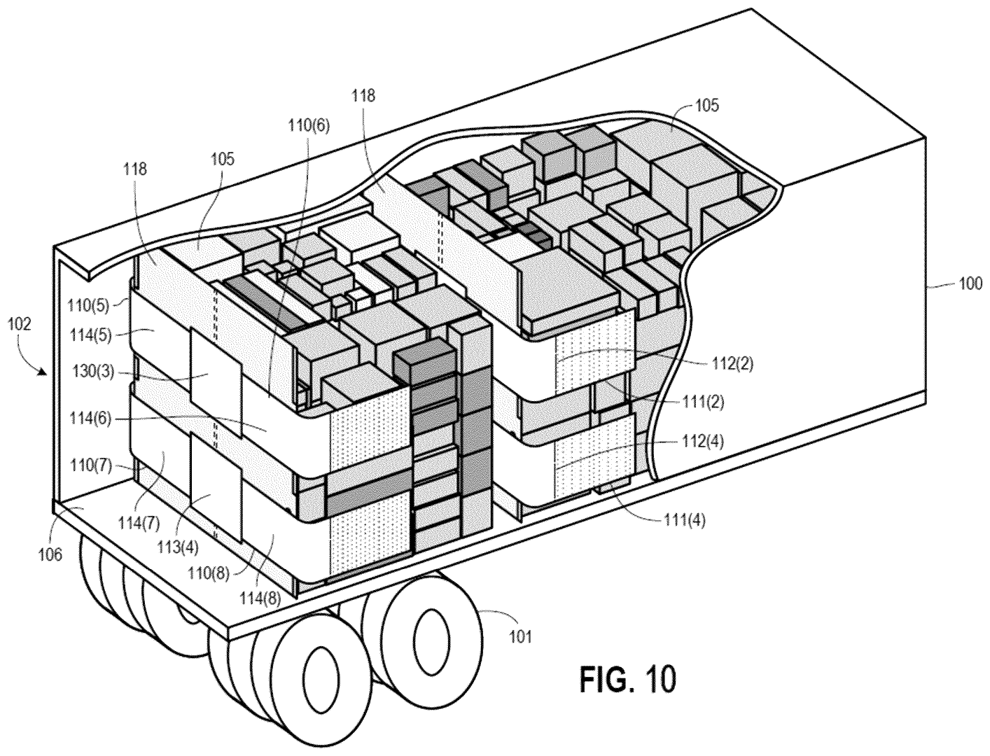

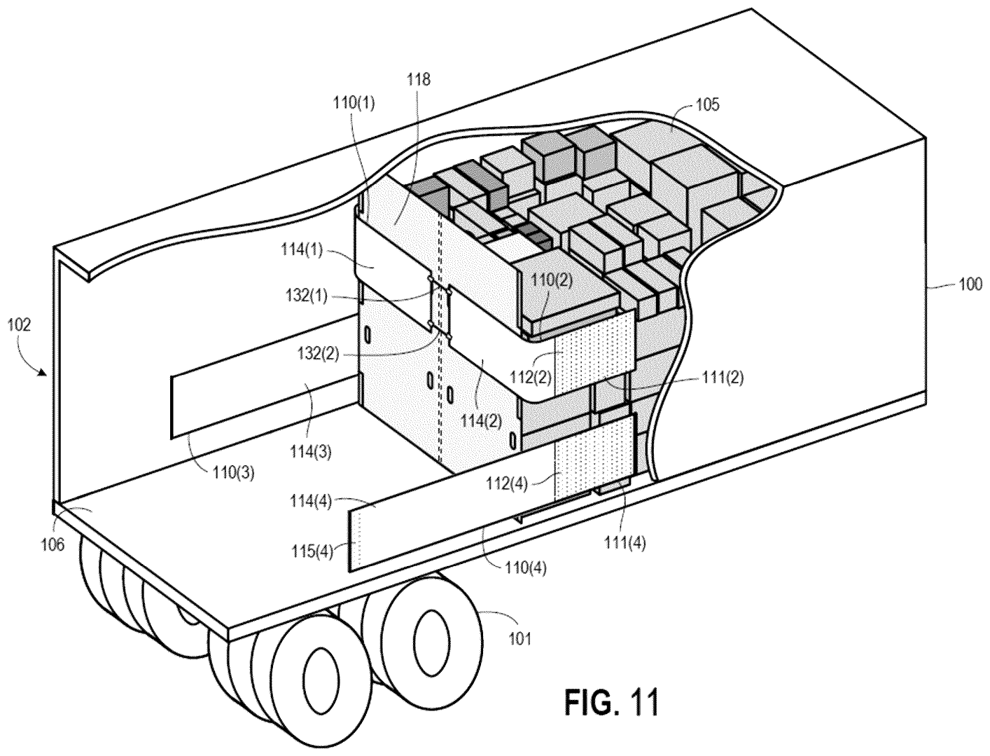

FIGS. 4A-4F show an example side edge guard 164 that may be utilized with the cargo restraint panel 118. The side edge guard 164, which may correspond to any of the side edge guards 164a-164d, may include a first back portion 178 and a second back portion 180 that cover portions of the back sheet 152B of the base panel 122. The first back portion 178 and the second back portion 180 may be separated by a gap 182. The gap 182 may provide a region configured to receive a load restraint strip 110 (e.g., a tail 114 of a load restraint strip 110 described in connection with FIGS. 9E and 9F). Each side edge guard 164a, 164b, 164c, 164d may include a corresponding gap 182a, 182b, 182c, 182d for each of the load restraint strips 110.

Additionally, the side edge guard 164 may include a front portion 184 that covers a portion of the front sheet 152A of the base panel 122. The front portions 184 of two adjacent side edge guards 164 may cover a portion of the front sheet 152A along an entire strip of the front sheet 152A adjacent to a side edge of the base panel 122. The first back portion 178, the second back portion 180, and the front portion 184 may be integrally joined with an edge portion 186 that covers the side edge of the base panel 122.

Corner edge guards 162 and/or side edge guards 164 may be injection molded and made of, for example, polypropylene (homopolymer or copolymer). Optionally, the material of the edge guards 160 may be reinforced (e.g., with glass or silica). In other examples, the edge guards 160 may be made of other possible materials that could include, e.g., acrylonitrile butadiene styrene (ABS), polyvinyl chloride PVC), polyethylene terephthalate (PET), high density polyethylene (HDPE), medium density polyethylene (MDPE), low density polyethylene (LDPE), Nylon, or polycarbonate. Optionally, two side edge guards 164 and two corner edge guards 162 could be combined into an integral, single piece edge guard 160 (e.g., molded as a single unit) and that is attached, as a single unit, to a side edge of the base panel 122.

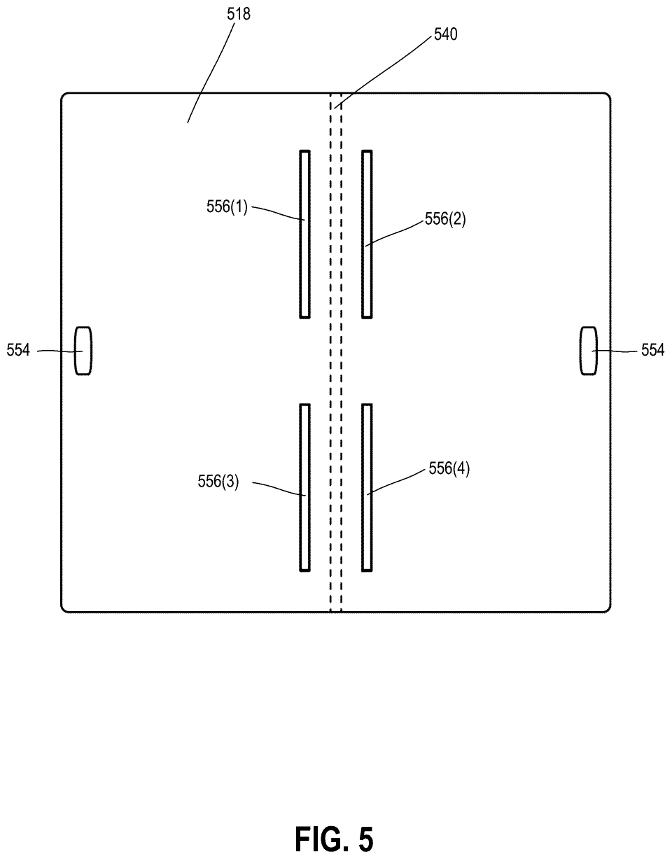

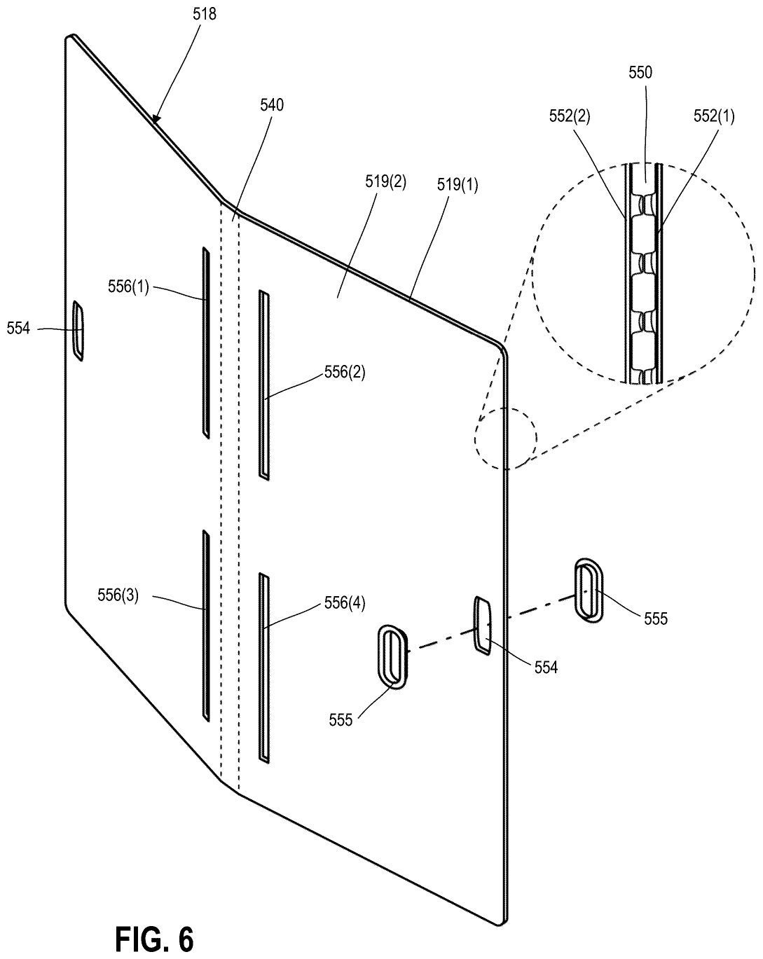

FIG. 5 shows an example cargo restraint panel 518 that may be used with a cargo container 100. FIG. 6 shows additional details of the cargo restraint panel 518. The cargo restraint panel 518 may include an extruded base panel. The extruded base panel may include an extruded, polymer corrugated panel that has two sheets integrally joined by corrugation flutes, with the sheets and flutes formed from the same polymer material and forming a unitary, integral structure of the base panel. The base panel may include one or more of edge guards, handles, or magnets, etc. to define the cargo restraint panel 518. The corrugation flutes may include bi-directional fluting using a rigid lightweight sheet resin, such as polypropylene or acetal or other similar polymer materials. The cargo restraint panel 518 may include the same base panel material as in embodiments of 1A-2C. The base panel of the cargo restraint panel 518 may be extruded or otherwise formed from, for example, polypropylene (homopolymer or copolymer). Optionally, the material of the base panel of the cargo restraint panel 518 may be reinforced (e.g., with glass or silica). The advantages of using polypropylene for the base panel of the cargo restraint panel 518 may include “toughness” (resistance to impact damage), or low dyne/surface energy (prevents excessive attachment to adhesive, making any adhesive-backed material easy to remove). In other examples, the base panel of the cargo restraint panel 518 may be extruded or otherwise formed from other possible materials that could include, e.g., acrylonitrile butadiene styrene (ABS), polyvinyl chloride PVC), polyethylene terephthalate (PET), high density polyethylene (HDPE), medium density polyethylene (MDPE), low density polyethylene (LDPE), Nylon, or polycarbonate.

One or more surfaces of the base panel and the cargo restraint panel 518 may also include a low surface energy textured facing that helps provide for clean removal of any adhesive strips used with the cargo restraint panel 518. The base panel of the cargo restraint panel 518 may be approximately 6-12 mm thick for both rigidity and flexural strength. The base panel of the cargo restraint panel 518 may be of other thicknesses depending on the cargo, layout, and/or applications of the cargo restraint panel 518 within the cargo container 100.

Additionally, as shown in FIG. 5, the cargo restraint panel 518 may include a center hinge 540 so that the cargo restraint panel 518 can fold in half and flat for storing and/or stacking. The center hinge 540 may provide for one-way folding of the cargo restraint panel 518. The center hinge 540 may be one or two perforated folds and may, for example, comprise a region in which flutes and a front sheet of a base panel have been omitted or removed.

The cargo restraint panel 518 may also include handle cut-outs 554 on one or more of the sides of the cargo restraint panel 518. The handle cut-outs 554 may be provided to assist the movement and installation of the cargo restraint panel 518. Each of the handle cut-outs 554 may also include a handle insert 555 that fits within and/or covers edges of the handle cut-outs 554 and provides an ergonomic handle surface to assist with the movement and installation of the cargo restraint panel. The handle inserts 555 may be polymer and/or injection molded. FIG. 6 shows an exemplary handle insert 555 and the handle cut-outs 554 for use with the cargo restraint panel 518.

Additionally, the cargo restraint panel 518 may include one or more slots or channels 556. The slots or channels 556 may be configured for a tightening tool to rest in so as to minimize the degree to which the tails 514 or the load restraint strip 510 are pushed away from the surface of the cargo restraint panel 518 during tightening, and thus minimize any loss of tension when the tool is removed. The cargo restraint panel 518 shown in FIG. 5 includes four slots or channels 556(1), 556(2), 556(3), and 556(4) (collectively referred to slots 556; generically referred to as slot or channel 556).

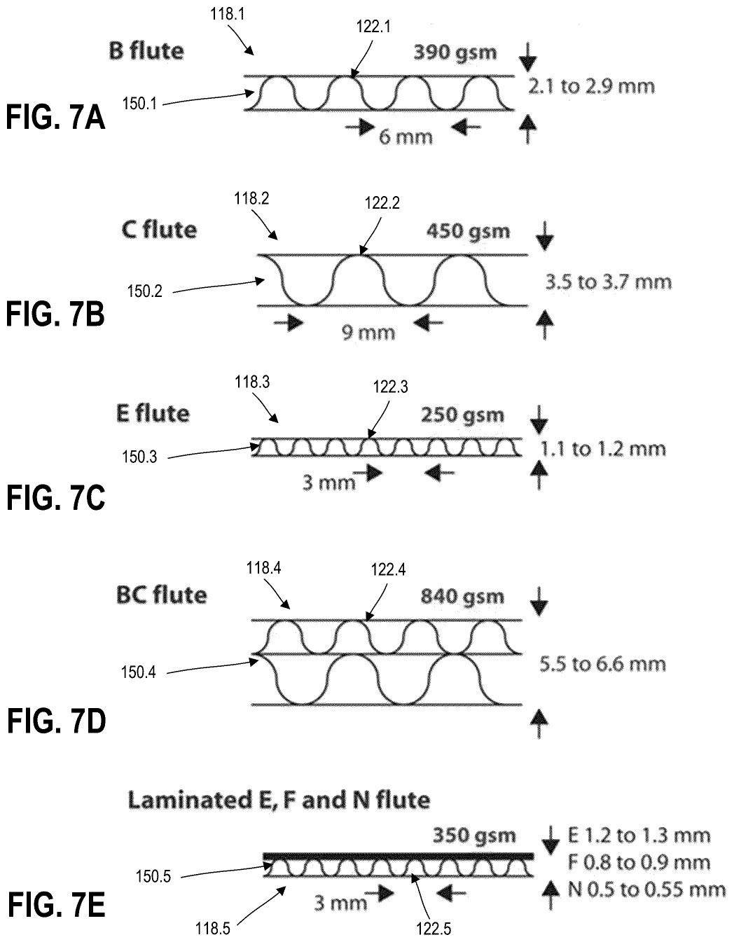

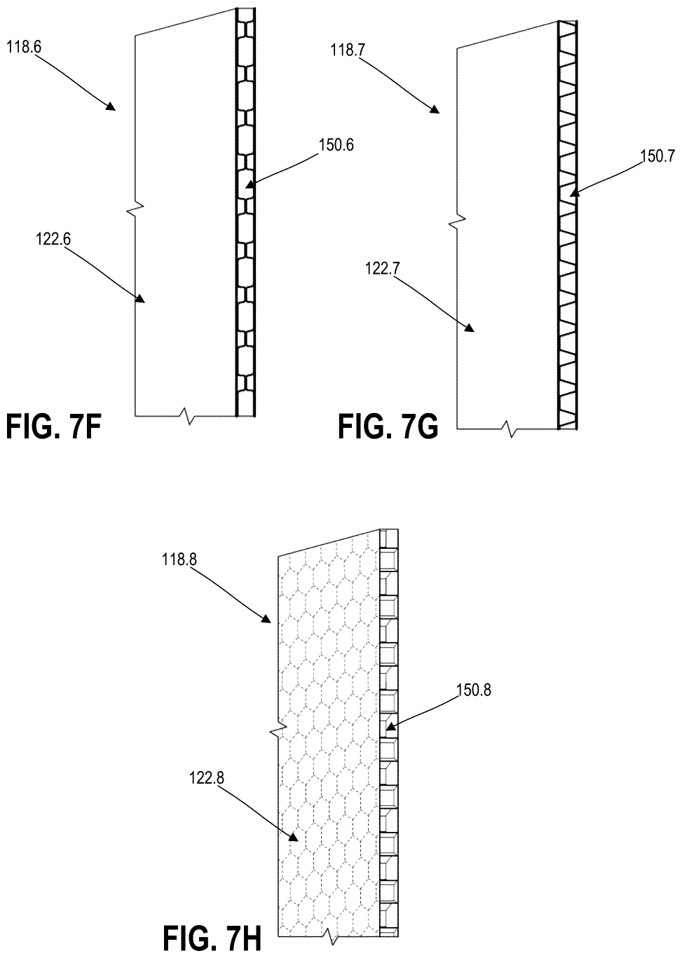

FIGS. 7A-7H show portions of an example cargo restraint panel with various exemplary cross-sections for the base panel. As illustrated in FIGS. 2A-2C, 6, and 7A-7H, the cargo restraint panel may include an extruded base panel. The base panel may include an extruded, polymer corrugated panel that has a front sheet integrally joined to a back sheet by corrugation flutes, with the sheets and flutes formed from the same polymer material and forming a unitary, integral structure of the base panel.

The base panel with the fluted corrugated material may be many different types and configurations of corrugations known and used in the art. FIG. 7A illustrates a portion of cargo restraint panel 118.1 with a base panel 122.1 that may include a fluted corrugated configuration 150.1 with a B-Flute with a flute thickness of approximately 2.5 mm. FIG. 7B illustrates a portion of another cargo restraint panel 118.2 with a base panel 122.2 that may include a fluted corrugated configuration 150.2 with a C-Flute with a flute thickness of approximately 3.6 mm. FIG. 7C illustrates a portion of another cargo restraint panel 118.3 with a base panel 122.3 that may include a fluted corrugated configuration 150.3 with a E-Flute with a flute thickness of approximately 1.5 mm. The E-Flute may be generally used for lighter applications. FIG. 7D illustrates a portion of another cargo restraint panel 118.4 with a base panel 122.4 that may include a fluted corrugated configuration 150.4 with a BC Flute, which is a double-wall combination made from one B-Flute, single wall sheet (approximately 2.1-2.9 mm thick), and one C-Flute, single wall sheet (approximately 3.5-3.7 mm thick), with a total thickness of approximately 5.6-6.7 mm thickness. The BC Flute may result in a strong corrugation used for extra thickness or holding strength. Another cargo restraint panel (not shown) with a base panel may include a fluted corrugated configuration with an AC Flute, which is a double-wall combination made from one A-Flute, single wall sheet (approximately 4.7 mm thick), and one C-Flute, single wall sheet (approximately 3.5-3.7 mm thick), with a total thickness of approximately 8.2-8.4 mm thickness. The AC Flute may result in a very strong corrugation used for extra holding strength. FIG. 7E illustrates a portion of yet another cargo restraint panel 118.5 with a base panel 122.5 may include a fluted corrugated configuration 150.5 with a laminated E, F, and N Flute that includes laminated one E-Flute, single wall sheet (approximately 1.2-1.3 mm thick), one F-Flute, single wall sheet (approximately 0.8-0.9 mm thick), and one N-Flute, single wall sheet (approximately 0.5-0.55 mm thick), with a total thickness of approximately 2.5-2.75 mm thickness. FIGS. 7F, 7G, and 7H illustrate portions of cargo restraint panels with base panel with alternative cross-sections or fluted corrugation configurations that may be used for the cargo restraint panel 118.6, 118.7, 118.8 with a base panel 122.6, 122.7, 122.8 and the fluted corrugated material 150.6, 150.7, 150.8, such as a honeycomb, bubble-board design option. Additionally, the cargo restraint panel 118 may be 100% recyclable at the end-of-use cycle.

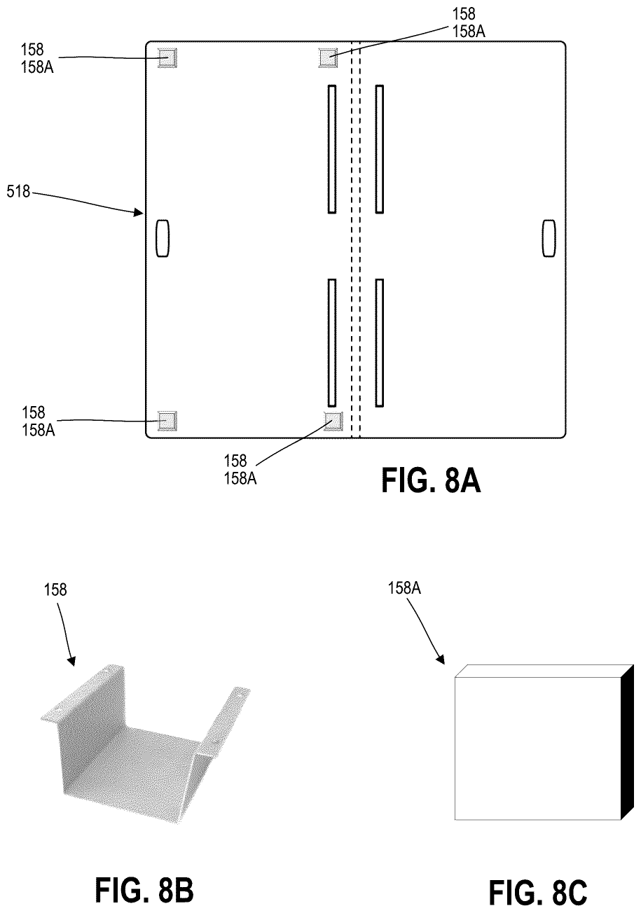

FIGS. 8A and 8B show an example pallet clip 158 (or pallet block 158A) for use with the cargo restraint panel 518 (the pallet clips 158 and/or pallet blocks 158A may also be used with the cargo restraint panel 118). FIG. 8A shows the cargo restraint panel 518 with four pallet clips or pallet blocks 158(1), 158(2), 158(3), 158(4) located in each of the corners of the cargo restraint panel 518. FIG. 8B shows an enlarged view of an example pallet clip 158. FIG. 8C shows an example pallet block 158A for use with the cargo restraint panel 518. The pallet block 158A could be e.g., foam (polystyrene or other polymer), wood, etc.

The pallet clips 158 and/or the pallet blocks 158A may be removable and placed at the corners on the bottom of one cargo restraint panel 518 and then stacked with other cargo restraint panels 518 on top without pallet clips 158 and/or pallet blocks 158A. Additional pallet clips 158 and/or the pallet blocks 158A may be utilized with the cargo restraint panel 518. The pallet clips 158 and/or the pallet blocks 158A may be used on a folded cargo restraint panel 518 used as a pallet base, and the pallet clips 158 and/or the pallet blocks 158A may be placed at the corners of folded half cargo restraint panel 518. The pallet clips 158 and/or pallet blocks 158A may be attached with various methods known and used in the art, such as for example, double-sided adhesive tape. The removable pallet clips 158 and/or the pallet blocks 158A may allow easier storage and moving of the stack of cargo restraint panels 518 with a forklift.

When storing and/or moving a stack of cargo restraint panels 518, the cargo restraint panels 518 may be folded in half, stacking the folded cargo restraint panels 518 on a cargo restraint panel 518 with the removable pallet clips 158 or pallet blocks 158A. The cargo restraint panels 518 may be stacked up to 50 or 60 high. The cargo restraint panels 518 may then be shrink-wrapped or otherwise secured with a strap or similar securing device. The cargo restraint panels 518 may then be shipped back to the shipping source for re-use, which facilitates sustainable reverse logistics and re-use, and green/eco-friendly shipping practices.

FIGS. 9A, 9B, 9C, 9D, 9E, 9F, 9G, and 9H show an example cargo container 100 during various stages of an example method for dual mode cargo restraint. Reference will be made to the cargo restraint panel 118, however, the cargo restraint panel 518 may be substituted or used in place of the cargo restraint panel 118. As indicated by the wheels 101, the cargo container 100 may comprise a semi trailer. Also or alternatively, dual mode cargo restraint as described herein can be used in a cargo container that may comprise another type of truck (or portion of another type of truck) used for transportation of cargo via roads, a shipping container, a rail car, or any other type of container used to hold cargo during transport. In each of FIGS. 9A through 9H, a rear end 102 of the cargo container may comprise doors (not shown) used to close the cargo container 100. Portions of a top and or a right side wall of the cargo container 100 have been omitted in FIGS. 9A through 9H to show interior details.

As shown in FIG. 9A, a front portion of the cargo container 100 has already been loaded with multiple cargo units 105. The cargo units 105 may, for example, comprise boxes, cartons, and/or other types of containers. The cargo units may be varying sizes, but may be small in size relative in an interior space of the cargo container 100. For example, an average volume of the cargo units 105 may be 3.375 cubic feet (cu. ft.) or less (e.g., 3.5 cu. ft., 3 cu. ft., 2.5 cu. ft., 2 cu. ft., 1.5 cu. ft., 1 cu. ft., etc.) per cargo unit 105. In the example of FIGS. 5A through 5H, the cargo units 105 are not palletized and may be loaded directly onto a floor 106 of the cargo container 100. The cargo units 105 may be stacked directly on one another and may extend from the floor 106 to (or near) an interior surface of the top of the cargo container 100, from an interior front wall of the cargo container 100, and from an interior left wall of the cargo container 100 to an interior of the right wall of the cargo container 100.

Also shown in FIG. 9A are four load restraint strips 110(1), 110(2), 110(3), and 110(4) (collectively referred to load restraint strips 110; generically referred to as load restraint strip 110). The load restraint strips 110 may all have a similar structure. As shown in the enlargement in FIG. 9A, each load restraint strip 110 may comprise a base layer 108 and a reinforcing layer 109 fixed to the base layer. Each of the load restraint strips 110 may further comprise an adhesive layer in an attachment region. Each of load restraint strips 110 may, for example, have a structure such as that described in any of U.S. Pat. Nos. 6,089,802, 6,227,779, 6,607,337, 6,896,459, 6,923,609, 7,018,151, 7,066,698, 7,290,969, 7,329,074, 8,113,752, 8,128,324, 8,403,607, 8,403,608, 8,403,609, 8,408,852, 8,419,329, 8,979,449, 9,090,194, 10,654,399, and/or U.S. patent application Ser. No. 18/195,583. All of said patents and the patent application, in their entireties, are incorporated by reference herein. Additional examples include, without limitation, load restraint strips sold under the name Ty-Gard 2000® and load restraint strips sold under the name Ty-Gard DS™ by Walnut Industries, Inc. of Bensalem, PA, US. The base layer 108, which may extend the entire length and width of the load restraint strip 110, may for example, comprise a non-woven spun-bonded material, a stitch-bonded material, or other type of material. The reinforcing layer 109, which may also extend the entire length and width of the load restraint strip 110, may, for example, comprise strands of reinforcing material (e.g., polyester fibers) that extend lengthwise along the load restraint strip 110. An adhesive layer may, for example, comprise a layer of adhesive applied to an attachment region located at one end of a load restraint strip 110.

In FIG. 9A, adhesive (not visible in FIG. 9A) of attachment regions 111(1) and 111(3) of the load restraint strips 110(1) and 110(3), respectively, is in contact with, and adhered to, the interior left wall of the cargo container 100. Adhesive 112(2) in attachment region 111(2) of the load restraint strip 100(2), as well as adhesive 112(4) in the attachment region 111(4) of the load restraint strip 100(4), is in contact with and adhered to the right interior wall of the cargo container 100. A tail 114(2) of the load restraint strip 110(2) extends from the attachment region 111(2) toward the rear 102 of the cargo container 100 and is held in place by an additional adhesive region 115(2) located near the end of the load restraint strip 110(2). A tail 114(4) of the load restraint strip 110(4) extends from the attachment region 111(4) toward the rear 102 of the cargo container 100 and is held in place by an additional adhesive region 115(4) located near the end of the load restraint strip 110(4). Similarly, tails 114(1) and 114(3) of the load restraint strips 110(1) and 110(3) extend from the attachment regions 111(1) and 111(3) toward the rear 102 and are held in place by additional adhesive regions, not shown, similar to the additional adhesive regions 115(2) and 115(4). So that the tails 114(1) through 114(4) may be easily pulled away from the interior walls, the additional adhesive regions 115(3) and 115(4) (and similar additional adhesive regions of the tails 114(1) and 114(3)) may be relatively small and/or may comprise an adhesive that has less bonding strength than the adhesive in the attachment regions 111(1) through 111(4).

In FIG. 9B, loading of the cargo units 105 has continued until a rear face of a stack of the cargo units 105 has reached a position in the interior of the cargo container 100 that is past the rear-most portions of the attachment regions 111(1) through 111(4). The stack of cargo units 105, which extends from the left interior wall of the cargo container 100 to the right interior wall of the cargo container 100, comprises at least four cargo units in the horizontal direction and at least four cargo units in the vertical direction. Because the cargo units 105 are not of uniform size or shape, some parts of the stack comprise more than four cargo units in the horizontal direction and more than four cargo units in the vertical direction. As can be appreciated from FIG. 9B, the stack of cargo units 105 would quickly become unstable if the cargo container 100 were to move forward with even modest acceleration. Unlike larger types of cargo, however, securing the load restraint strips 110 around the rear of the stack may not, without more, provide sufficient restraint. Cargo units not covered by one of the load restraint strips 110 may slip through a gap. Even if one of the cargo units 105 only partially dislodges to extend through such a gap, the resulting void in the stack could cause other cargo units 105 to shift and/or be damaged. Although additional and/or larger load restraint strips could be added to prevent gaps, this would not address another problem. In particular, if the load restraint strips 110 were directly wrapped around the end of the cargo unit 105 stack, the tension in the load restraint strips 110 (from tightening during securement and/or from force of the cargo units 105 pressing against the load restraint strips 110) would tend to crush and/or dislodge cargo units 105 at the rear corners of the stack. To address this problem, a cargo restraint panel may be placed at the rear of the stack of cargo units 105, and the load restraint strips 110 may then be secured around the cargo restraint panel.

In FIG. 9C, a cargo restraint panel 118 has been placed adjacent to (e.g., against and/or in contact with) the rear face of the stack of cargo units 105. The cargo restraint panel 118 may comprise a base panel 122 with a first sheet or front sheet 152A with a first major surface 119(1) facing the stack of cargo units 105, a second sheet or back sheet 152B with a second major surface 119(2) (which may be the same as or similar to the first major surface) facing away from the stack, and corrugation flutes 150 located between the front sheet 152A and the back sheet 152B. The front sheet 152A may be integrally joined to the back sheet 152B by the corrugation flutes 150, with the sheets 152A, 152B and corrugation flutes 150 formed from the same polymer material and forming a unitary, integral structure of the base panel 122.

The cargo restraint panel 118 may rest on the floor 106, and may extend above the stack of cargo units 105. As explained above, the cargo restraint panel 118 may include a center hinge 140 so that the cargo restraint panel 118 can fold flat for storing. As illustrated in FIG. 9C, the cargo restraint panel 118 may be folded into a V-shape using the center hinge 140 during installation, so that the cargo restraint panel 118 will stand by itself while preparing to secure the cargo restraint panel 118 against the stack of cargo units 105. A side of the cargo restraint panel 118 may be positioned near the interior left wall of the cargo container 100 and an opposite side of the cargo restraint panel 118 may be positioned near the interior right wall of the cargo container 100.

In the example of FIG. 9D, the cargo restraint panel 118 may be flattened and straightened so that the entire cargo restraint panel 118 is adjacent to (e.g., against and/or in contact with) the rear face of the stack of cargo units 105. When flattened and straightened, the cargo restraint panel 118 may extend from one side of the cargo container 100 to the opposite side of the cargo container 100, with the side of the cargo restraint panel 118 positioned near to the interior left wall of the cargo container 100 and the opposite side of the cargo restraint panel 118 positioned near to the interior right wall of the cargo container 100. Additionally, the sides of the cargo restraint panel 118 may not be mechanically interlocked with the floor 106, with the left interior wall, with the right interior wall, or with the ceiling of the cargo container 100. For example, there are no bolts, hooks, latches, or other mechanical elements that link the bottom side to the floor 106, that link the left side to the interior left wall, that link the right side to the interior right wall, or that link the top side to the ceiling.

In FIG. 9E, the tails 114(1) and 114(2) of the load restraint strips 110(1) and 110(2) are pulled away from the interior walls and are wrapped around the cargo restraint panel 118. In particular, the tail 114(1) of the first load restraint strip 110(1) is wrapped around, and brought into contact with, the second major surface 119(2) of the cargo restraint panel 118 and along the gap 182 of the side edge guard 164, and the tail 114(2) of the second load restraint strip 110(2) is wrapped around, and brought into contact with, the second major surface 119(2) of the cargo restraint panel 118 and along the gap 182 of the side edge guard 164.

In FIG. 9F, a tightening tool 125 is placed over the tails 114(1) and 114(2). The tool 125 includes a pair of tines 126 that define a slot. Only one of the tines 126 is visible in FIG. 9F. The tines 126 of the tool 125 may be slid over the overlapped ends of the tails 114(1) and 114(2) so as to hold those overlapped ends in the slot between tines 126. After placement of tool 125, handle 127 is held stationary and handle 128 is rotated in the direction indicated. This rotates the tines 126 and draws the tails 114(1) and 114(2) together, thereby tensioning the tails 114(1) and 114(2) to apply force against the cargo restraint panel 118 and push the cargo restraint panel 118 against the stack of cargo units 105. The ends of the tails 114(1) and 114(2) may then be secured together by applying an adhesive backed connecting patch 130(1) over those ends, and the tool 125 removed, as shown in FIG. 9G. The connecting patch 130(1) may, for example, comprise a patch of material such as that sold under the name Ty-Patch 2000® by Walnut Industries, Inc. of Bensalem, PA, US. The connecting patch 130(1) may, for example, comprise a backing material, similar to that of the load restraint strips 110, with reinforcing fibers similar to those of the load restraint strips 110. An adhesive layer that contacts the tails 114(1) and 114(2) may comprise an adhesive that is similar to that of the adhesive layers 112(2) and 114(4), or may comprise a different type of adhesive (e.g., a rubber cement selected to bond to surfaces the tails 114(1) and 114(2).

The tails 114(3) and 114(4) of the load restraint strips 110(3) and 110(4) may, in a manner similar to that shown in FIGS. 9E and 9F, be wrapped around the cargo restraint panel 118 and tightened using the tool 125. A connecting patch 130(2) may be applied, in a manner similar to that described for the connecting patch 130(1), to the tightened tails 114(3) and 114(4), and the tool 125 removed, as shown in FIG. 9H. In the configuration shown in FIG. 9H, the load restraint strips 110 and the cargo restraint panel 118 provide dual mode securement of the cargo units 105. The cargo restraint panel 118 is securely held in position against the stack of cargo units 105 by the load restraint strips 110, but without need of special hardware or attachment mechanisms to connect the cargo restraint panel 118 to the walls, floor, or ceiling of the cargo container 100. The cargo restraint panel 118, while held against the cargo unit 105 stack by the load restraint strips 110, acts as a secure bulkhead to prevent shifting of the cargo units during acceleration of the cargo container 100. When the cargo container 100 reaches its destination, the cargo restraint panel 118 can be easily removed by cutting the load restraint strips 110 with a knife (e.g., by cutting portions of the load restraint strips 110 between the cargo restraint panel 118 and interior walls of the cargo container 100). The cargo restraint panel 118, because of their corrugation, extruded sheets, and handles, may be lightweight and easily handled. The cargo restraint panel 118 may be reused.

Although FIG. 9H shows a relatively large space behind the cargo restraint panel 118, this need not be the case. For example, prior to performing the operations explained above (e.g., before affixing the load restraint strips 110, placing the cargo restraint panel 118, etc.), additional cargo units 105 may be loaded, and the locations of the load restraint strips 110 and cargo restraint panel 118 may be rearward of where shown in FIG. 5H. Alternatively, the locations of the load restraint strips 110 and cargo restraint panel 118 may be forward of where shown in FIG. 9H (e.g., if fewer cargo units 105 are loaded in the forward portion of the cargo container 100).

Also or alternatively, and as shown in FIG. 10, additional cargo units 105 may be loaded behind the cargo restraint panel 118. Reference will be made to the cargo restraint panel 118, however, the cargo restraint panel 518 may be substituted or used in place of the cargo restraint panel 118. For example, and as shown in FIG. 10, a second stack of cargo units 105 begins immediately behind the cargo restraint panel 118. Attachment regions of load restraint strips 110(5) through 110(8) (which may be similar to the load restraint strips 110(1) through 110(4)) may then be affixed, similar to the affixation of the attachment regions 112(1) through 112(4) of the load restraint strips 110(1) through 110(4). A cargo restraint panel 118A (which may be similar to the cargo restraint panel 118) may then be placed, similar to the placement of the cargo restraint panel 118, adjacent to the rear of the second stack of cargo units 105. Tails 114(5) and 114(6) of the load restraint strips 110(5) and 110(6), as well as tails 114(7) and 114(8) of the load restraint strips 110(7) and 110(8), may then be wrapped, tightened, and secured (with adhesive connecting patches 130(3) and 130(4)) similar to how tails 114(1) and 114(2) of load restraint strips 110(1) and 110(2) were wrapped, tightened, and secured.

As described above in connection with FIG. 9F, tails of load restraint strips, after wrapping around cargo restraint panel may be tightened using a tool 125 to draw the tails together and create tension in the tails. This tension helps to firmly hold the cargo restraint panel in place. Because of the nature of many types of smaller, unpalletized cargo units that may be restrained using dual-mode cargo restraint, minimal tension may sufficient. For example, the cargo units 105 may comprise boxes or other containers that are generally lightweight, and the total mass of a stack may be such that substantial pre-tensioning of the tails is unnecessary. Moreover, if the cargo units 105 comprise cardboard cartons or other containers that are easily crushed or deformed, excessive tensioning of the tails may lead to excessive force against those cargo units and may cause damage.

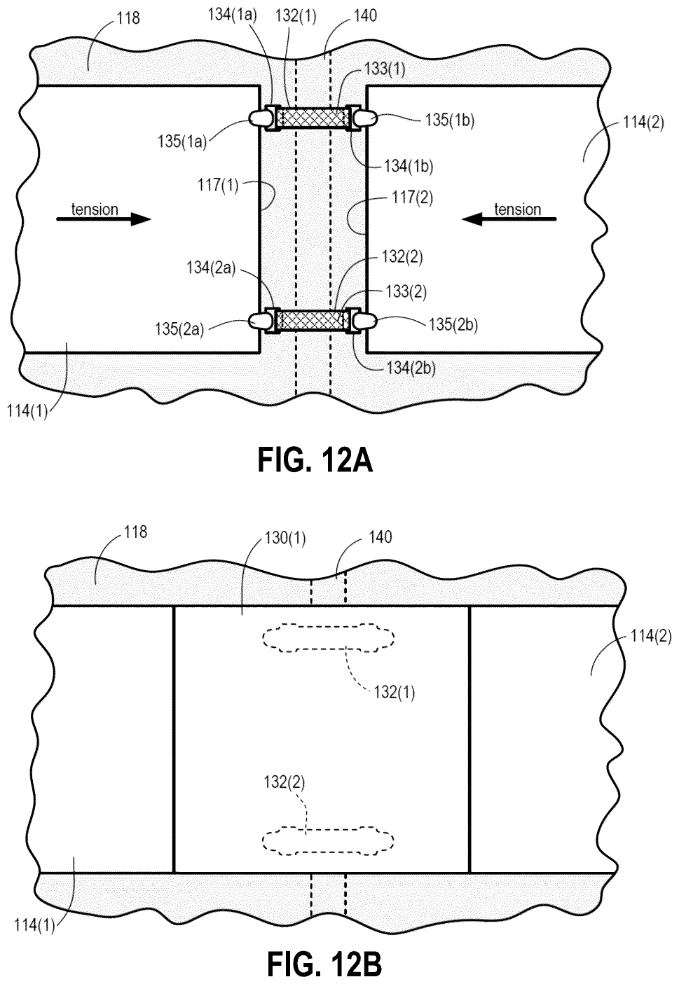

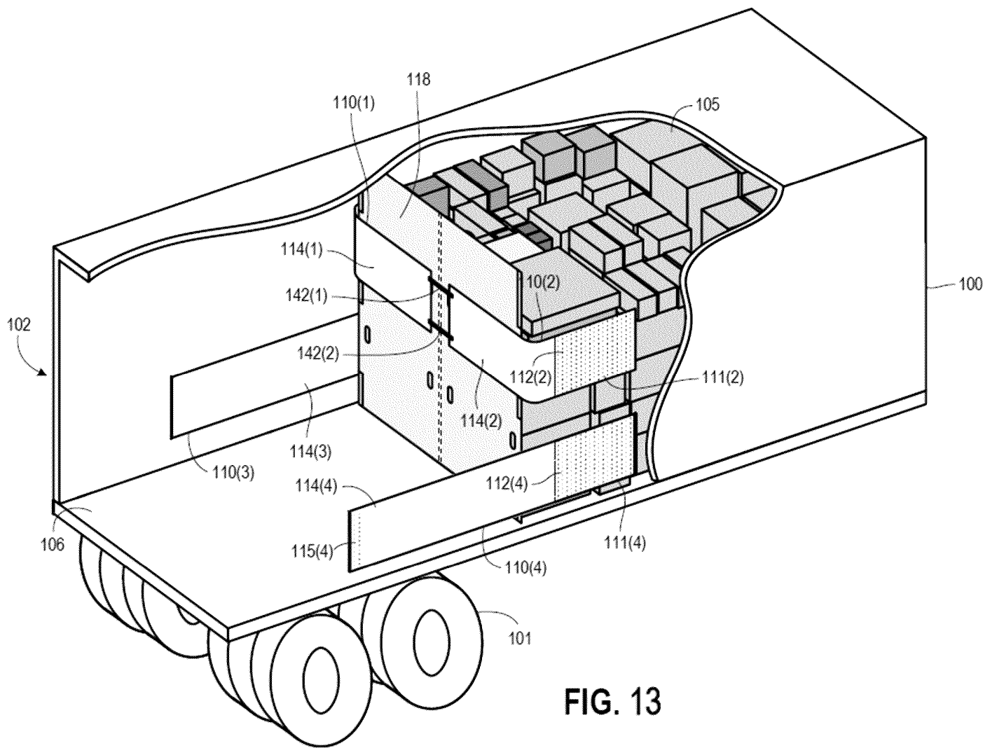

FIGS. 11, 12A, and 12B show an example of dual-mode cargo restraint in which tails of load restraint strips are tensioned without use of a tool such as the tightening tool 125. Instead, load restraint strip tails may be connected using tensioned elastic strips that pull the tails together with minimal force (e.g., 10 to 20 pounds). Reference will be made to the cargo restraint panel 118, however, the cargo restraint panel 518 may be substituted or used in place of the cargo restraint panel 118. In the configuration of FIG. 11, the load restraint strips 110(1) through 110(4) have been affixed, and the cargo restraint panel 118 has been placed, in a manner similar to that described above. The tails 114(1) and 114(2) of the load restraint strips 110(1) and 110(2) have also been wrapped around the cargo restraint panel 118 in a manner similar to that described above. In FIG. 11, however, the ends of the tails 114(1) and 114(2) have been trimmed so that there is a gap (e.g., 6 to 12 inches) between the ends of the tails. Those ends are then connected using elastic strips 132(1) and 132(2).

FIG. 12A shows an enlarged view of the ends of the tails 114(1) and 114(2), in FIG. 11, from a position immediately behind the cargo restraint panel 118. Elastic strip 132(1) comprises an elastic member 133(1) that is attached, via wire links 134(1a) and 134(1b), to clips 135(1a) and 135(1b). The elastic member 133(1) comprises a strip of material that, when elongated, creates tension that pulls the clips 135(1a) and 135(1b) together. Examples of material for the elastic member 133(1) may comprise rubber, combination polyester/rubber textiles, and/or other elastic materials. The clips 135(1a) and 135(1b) may be spring-loaded and openable to engage an edge of an end of a load restraint strip tail with a jaw of the clip, and closable to grip that edge. The jaws of clips 135(1a) and 135(1b) may comprise teeth to better grip that edge. The elastic strip 132(2) may be similar to the elastic strip 132(1) and may comprise an elastic member 133(2), wire links 134(2a) and 134(2b), and clips 135(2a) and 135(2b).

To connect the tails 114(1) and 114(2) together as shown in FIG. 12A, the clips 135(1a) and 135(2a) may be attached to the edge 117(1) of the tail 114(1). The clips 135(1b) and 135(2b) may then be pulled toward, and attached to, the edge 117(2) of the tail 114(2). The distance between the edges 117(1) and 117(2) may such that the elastic members 133(1) and 133(2) are elongated, thereby creating tension in the elastic members 133(1) and 133(2) that pulls the clips 135(1b) and 135(2b) (and attached edge 117(2)) toward the clips 135(1a) and 135(2a) (and attached edge 117(1)), and thereby tensioning the tails 114(1) and 114(2).

After connecting the tails 114(1) and 114(2) together as shown in FIG. 12A, the tails 114(1) and 114(2) may be secured together by applying the connecting patch 130(1) to the ends of the tails 114(1) and 114(2). FIG. 12B shows an enlarged view of the ends of the tails 114(1) and 114(2) similar to FIG. 12A, but showing the connecting patch 130(1) adhered to the ends of the tails 114(1) and 114(2). The connecting patch 130(1) may also be adhered to the elastic strips 132(1) and 132(2) and to portions of the cargo restraint panel 118 exposed between the edges 117(1) and 117(2). However, the elastic strips 132(1) and 132(2) are relatively inexpensive and may be treated as disposable. Because the extent of the cargo restraint panel 118 contacted by adhesive from the connecting patch 130(1) is limited, the connecting patch may be largely or completely removeable from the cargo restraint panel 118. Tails 114(3) and 114(4) (FIG. 11) may similarly be connected and tensioned using elastic strips similar to elastic strips 132(1) and 132(2), and secured with a connecting patch.

Elastic strips may have configurations other than that shown in FIG. 12A. As indicated above, various types of elastic materials may be used. Any of various types of clips may be used. Clips may be attached to an elastic member in ways other than via wire links (e.g., riveting, gluing, and/or otherwise attaching tabs or other extensions of clips to ends of an elastic member). An elastic strip need not use clips and may be attached to load restraint strip tails in other ways.

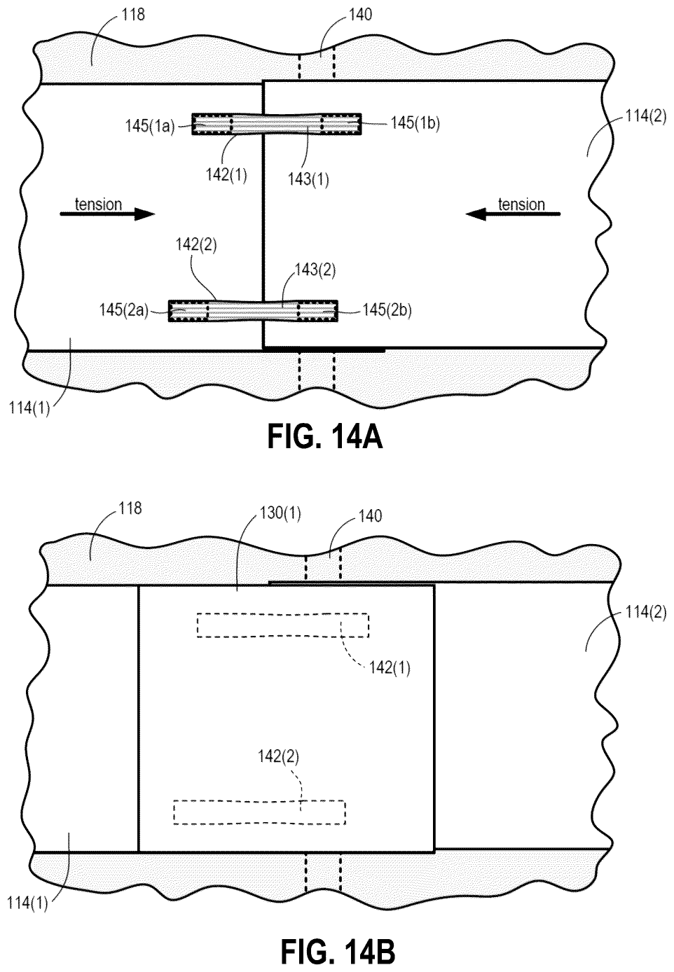

FIGS. 13, 14A, and 14B show an example of dual-mode cargo restraint using elastic strips without clips. Reference will be made to the cargo restraint panel 118, however, the cargo restraint panel 518 may be substituted or used in place of the cargo restraint panel 118. In the configuration of FIG. 13, the load restraint strips 110(1) through 110(4) have been affixed, and the cargo restraint panel 118 have been placed, in a manner similar to that described above. The tails 114(1) and 114(2) of the load restraint strips 110(1) and 110(2) have also been wrapped around the cargo restraint panel 118 in a manner similar to that described above. In FIG. 13, however, the ends of the tails 114(1) and 114(2) have been connected using elastic strips 142(1) and 142(2).

FIG. 14A shows an enlarged view of the ends of the tails 114(1) and 114(2), in FIG. 13, from a position immediately behind the cargo restraint panel 118. Elastic strip 142(1) comprises an elastic member 143(1). A surface of the elastic strip 142(1) configured to attach to load restraint strip tails, which surface is not visible in FIG. 14A, includes adhesive patches 145(1a) and 145(1b). The adhesive of patches 145(1a) and 145(1b) may be applied directly to the material of the elastic member 143(1), or may be applied to separate elements (e.g., flexible fabric or polymer sheets) that are sewn or otherwise attached to the elastic member 143(1). The elastic member 143(1) may comprise a strip of material that is similar to the material of the elastic member 133(1) and that, when elongated, creates tension that pulls the patches 145(1a) and 145(1b) together. The elastic strip 142(2) may be similar to the elastic strip 142(1) and may comprise one or more adhesive patches 145(2a) and 145(2b).

To connect the tails 114(1) and 114(2) together as shown in FIG. 14A, the adhesive patches 145(1a) and 145(2a) may be attached to the tail 114(1). The patches 145(1b) and 145(2b) may then be pulled toward, and attached to, the tail 114(2). The locations of attachment to the tail 114(2) may be selected such that the elastic members 143(1) and 143(2) are elongated, thereby creating tension in the elastic members 143(1) and 143(2) that pulls the patches 145(1b) and 145(2b) (and attached tail 114(2)) toward the patches 145(1a) and 145(2a) (and attached tail 114(1)), and thereby tensioning the tails 114(1) and 114(2).

After connecting the tails 114(1) and 114(2) together as shown in FIG. 14A, the tails 114(1) and 114(2) may be secured together by applying the connecting patch 130(1) to the ends of the tails 114(1) and 114(2). FIG. 14B shows an enlarged view of the ends of the tails 114(1) and 114(2) similar to FIG. 14A, but showing the connecting patch adhered to the ends of the tails 114(1) and 114(2). The connecting patch 130(1) may also be adhered to the elastic strips 142(1) and 142(2). However, the elastic strips 142(1) and 142(2) are relatively inexpensive and may be treated as disposable. Tails 114(3) and 114(4) (FIG. 13) may similarly be connected and tensioned using elastic strips similar to elastic strips 142(1) and 142(2), and secured with a connecting patch.

In the configuration of FIGS. 14A and 14B, there is no gap between the tails 114(1) and 114(2). Alternatively, a gap may be created, similar to that shown in FIG. 12A, prior to connecting the tails 114(1) and 114(2) using the elastic strips 142(1) and 142(2).

Although examples above show one cargo restraint panel used to create a bulkhead to secure cargo, more cargo restraint panels may be used. Similarly, and although examples above show two pairs of opposing load restraint strips used to hold the cargo restraint panel in place, more or fewer pairs of opposing load restraint strips may be used.

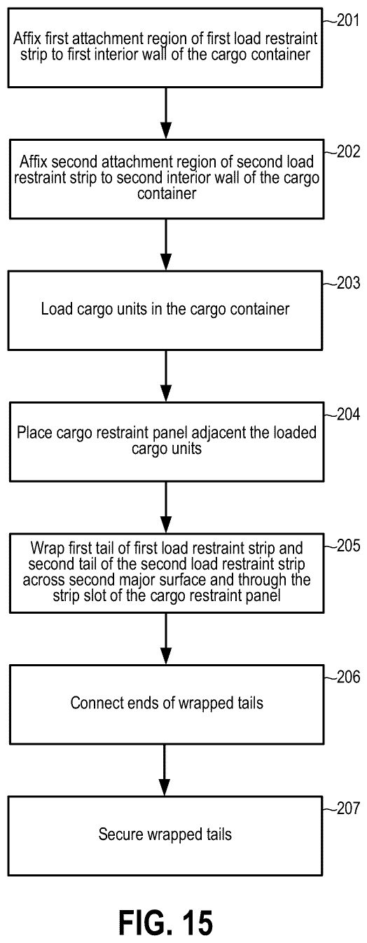

FIG. 15 is a block diagram showing steps of an example method for dual mode cargo restraint. Reference will be made to the cargo restraint panel 118, however, the cargo restraint panel 518 may be substituted or used in place of the cargo restraint panel 118. In step 201, a first attachment region of a first load restraint strip may be affixed to a first interior wall of a cargo container. The first load restraint strip may comprise a first base layer, a first reinforcement layer fixed to the first base layer, and an exposed first adhesive layer in the first attachment region. An example of step 201 is affixing of the attachment region 111(1) of the load restraint strip 110(1) to the left interior wall of the cargo container 100. Step 201 may be repeated for one or more additional first load restraint strips (e.g., for the load restraint strip 110(2)).

In step 202, a second attachment region of a second load restraint strip may be affixed to a second interior wall of a cargo container. The second load restraint strip may comprise a second base layer, a second reinforcement layer fixed to the second base layer, and an exposed second adhesive layer in the second attachment region. An example of step 202 is affixing of the attachment region 111(2) of the load restraint strip 110(2) to the right interior wall of the cargo container 100. Step 201 may be repeated for one or more additional load restraint strips (e.g., for the load restraint strip 110(4)).

In step 203, cargo units may be loaded in the cargo container. The loaded cargo units may be stacked to a height of at least four cargo units and to a width of at least four cargo units. An example of step 203 is loading of the cargo units 105 in the cargo container 100.

In step 204, a cargo restraint panel may be placed adjacent to the loaded cargo units. Initially, the cargo restraint panel may be placed in a semi-folded, V-shape configuration. The cargo restraint panel may be flattened and straightened so that the entire cargo restraint panel is adjacent to (e.g., against and/or in contact with) the rear face of the stack of cargo units. When flattened and straightened, the cargo restraint panel may extend from one side of the cargo container to the opposite side of the cargo container, with the side of the cargo restraint panel positioned near to the interior left wall of the cargo container and the opposite side of the cargo restraint panel positioned near to the interior right wall of the cargo container. The cargo restraint panel may comprise a base panel with a first sheet or front sheet with a first major surface facing the loaded cargo units, a second sheet or back sheet with a second major surface facing away from the loaded cargo units, and corrugation flutes located between the front sheet and the back sheet. The front sheet may be integrally joined to the back sheet by the corrugation flutes, with the sheets and the corrugation flutes formed from the same polymer material and forming a unitary, integral structure of the base panel. An example of step 204 is placing of the cargo restraint panel 118 (or 518) in the cargo container 100. In step 205, a first tail of the first load restraint strip and a second tail of the second load restraint strip may be wrapped across the second major surface of the cargo restraint panel. An example of step 205 is the wrapping of the tails 114(1) and 114(2) across the cargo restraint panel 118 (or 518). Step 205 may be repeated for one or more additional pairs of first and second restraint strips (e.g., for the tails 114(3) and 114(4) of the load restraint strips 110(3) and 110(4)).

In step 206, ends of the wrapped first and second tails may be connected. Examples of this connecting include connecting using a tightening tool such as the tool 125 and connecting using elastic strips such as the elastic strips 132(1) and 132(2) and/or the elastic strips 142(1) and 142(2). Step 206 may be repeated for one or more additional pairs of first and second restraint strips (e.g., for the tails 114(3) and 114(4) of the load restraint strips 110(3) and 110(4)).

In step 207, the wrapped first tail may be secured to the wrapped second tail. An example of step 207 is applying the connecting patch 130(1) to the tails 114(1) and 114(2). Step 207 may be repeated for one or more additional pairs of first and second restraint strips (e.g., for the tails 114(3) and 114(4) of the load restraint strips 110(3) and 110(4)).

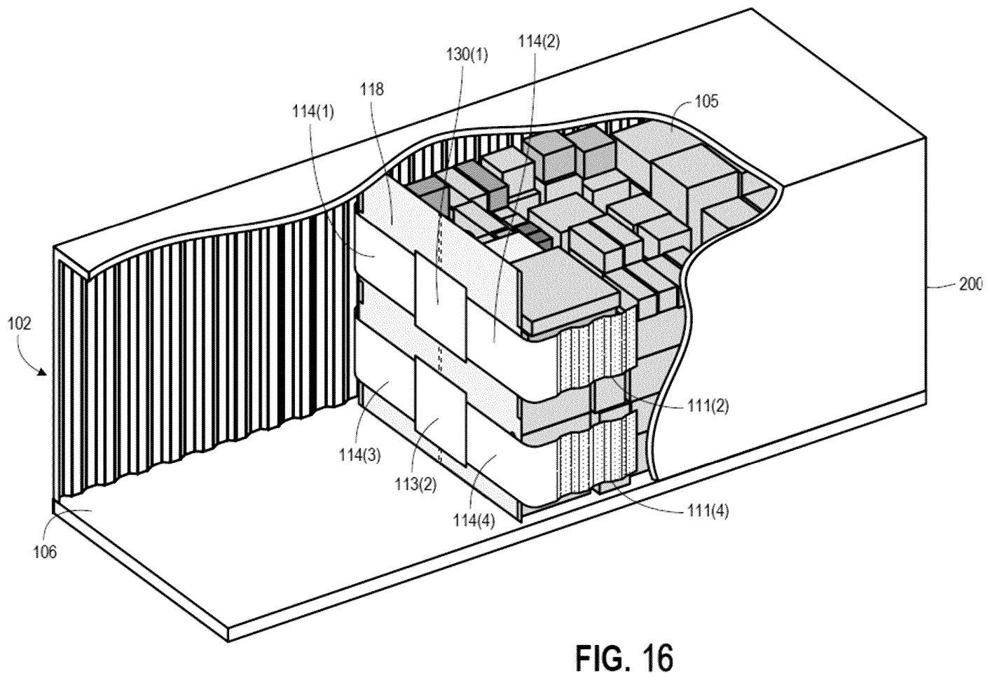

As explained above, dual mode cargo restraint such as is described herein may be used in any of various types of cargo containers. FIG. 16 shows an example of dual mode cargo restraint in another type of cargo container. FIG. 16 is similar to FIG. 9H, except that in FIG. 16 the dual mode cargo restraint shown in FIG. 9H has been used in a cargo container 200 that comprises a multi-mode shipping container. Reference will be made to the cargo restraint panel 118 in FIG. 16, however, the cargo restraint panel 518 may be substituted or used in place of the cargo restraint panel 118.

The foregoing has been presented for purposes of example. The foregoing is not intended to be exhaustive or to limit features to the precise form disclosed. The examples discussed herein were chosen and described in order to explain principles and the nature of various examples and their practical application to enable one skilled in the art to use these and other implementations with various modifications as are suited to the particular use contemplated. The scope of this disclosure encompasses, but is not limited to, any and all combinations, subcombinations, and permutations of structure, operations, and/or other features described herein and in the accompanying drawing figures.

1. A method of securing cargo in a cargo container, the method comprising:
affixing a first attachment region of a first load restraint strip to a first interior wall of the cargo container;
affixing a second attachment region of a second load restraint strip to a second interior wall of the cargo container;
loading cargo units in the cargo container, wherein the loaded cargo units are stacked to a height of at least four cargo units and to a width of at least four cargo units;
placing a cargo restraint panel adjacent to the loaded cargo units, wherein the cargo restraint panel comprises a base panel formed from a polymer material, the base panel comprising a first sheet integrally joined to a second sheet by corrugations to form a unitary, integral structure of the base panel, wherein the first sheet includes a first major surface facing the loaded cargo units and the second sheet includes a second major surface facing away from the loaded cargo units;
after placing the cargo restraint panel, wrapping a first tail of the first load restraint strip and a second tail of the second load restraint strip across the second major surface of the cargo restraint panel; and
securing the wrapped first tail to the wrapped second tail.

2. The method of claim 1, wherein the base panel is formed from one or more of:
polypropylene, acrylonitrile butadiene styrene (ABS), polyvinyl chloride PVC), polyethylene terephthalate (PET), high density polyethylene (HDPE), medium density polyethylene (MDPE), low density polyethylene (LDPE), Nylon, or polycarbonate.

3. The method of claim 1, wherein the base panel comprises a thickness of between 6 and 12 mm.

4. The method of claim 1, wherein the cargo restraint panel comprises a center hinge configured to allow folding of the cargo restraint panel, the center hinge comprising a region of the base panel in which a portion of the first sheet and a portion of the corrugations are absent, and in which a portion of the second sheet is present.

5. The method of claim 1, wherein the cargo restraint panel comprises one or more handle cut-outs located on one or more sides of the cargo restraint panel.

6. The method of claim 1, wherein cargo restraint panel comprises a hinge, a first magnet, and a magnetic attraction element comprising at least one of a second magnet or a plate, and wherein the first magnet and the magnetic attraction element are positioned so that, when the cargo restraint panel is placed into a folded configuration by folding along the hinge, the first magnet attracts the magnetic attraction element to bias the cargo restraint panel in the folded configuration.

7. The method of claim 1, wherein the cargo restraint panel comprises one or more edge guards covering one or more edges of the base panel.

8. The method of claim 7, wherein the one or more edge guards comprise a first portion covering a region of one of the first sheet or the second sheet and a second portion covering a corresponding portion of the other of the first sheet or the second sheet, wherein the first portion and the second portion are integrally joined with an edge portion that covers a portion of the one or more edges of the base panel, and the one or more edge guards further comprising one or more glide rails that extend from the edge portion.

9. The method of claim 1, wherein the first load restraint strip comprises a first base layer, a first reinforcement layer fixed to the first base layer, and an exposed first adhesive layer in the first attachment region and the second load restraint strip comprises a second base layer, a second reinforcement layer fixed to the second base layer, and an exposed second adhesive layer in the second attachment region.

10. A method of securing cargo in a cargo container, the method comprising:
affixing a first attachment region of a first load restraint strip to a first interior wall of the cargo container, wherein the first load restraint strip comprises a first base layer, a first reinforcement layer fixed to the first base layer, and an exposed first adhesive layer in the first attachment region;
affixing a second attachment region of a second load restraint strip to a second interior wall of the cargo container, wherein the second load restraint strip comprises a second base layer, a second reinforcement layer fixed to the second base layer, and an exposed second adhesive layer in the second attachment region;
loading cargo units in the cargo container;
placing a cargo restraint panel adjacent to the loaded cargo units, the cargo restraint panel comprising a base panel formed from a polymer material, the base panel comprising a first sheet integrally joined to a second sheet by corrugations to form a unitary, integral structure of the base panel, wherein the first sheet includes a first major surface facing the loaded cargo units and the second sheet includes a second major surface facing away from the loaded cargo units, wherein the cargo restraint panel further comprises one or more edge guards covering one or more edges of the base panel;
after placing the cargo restraint panel, wrapping a first tail of the first load restraint strip and a second tail of the second load restraint strip across the second major surface of the cargo restraint panel; and
after connecting the first tail to the second tail, securing the wrapped first tail to the wrapped second tail.

11. The method of claim 10, wherein the base panel is formed from one or more of:
polypropylene, acrylonitrile butadiene styrene (ABS), polyvinyl chloride PVC), polyethylene terephthalate (PET), high density polyethylene (HDPE), medium density polyethylene (MDPE), low density polyethylene (LDPE), Nylon, or polycarbonate.

12. The method of claim 10, wherein the cargo restraint panel comprises a center hinge configured to allow folding of the cargo restraint panel, the center hinge comprising a region of the base panel in which a portion of the first sheet and a portion of the corrugations are absent, and in which a portion of the second sheet is present.

13. The method of claim 10, wherein the cargo restraint panel comprises one or more handle cut-outs located on one or more sides of the cargo restraint panel.

14. The method of claim 10, wherein the one or more edge guards comprise a first portion covering a region of one of the first sheet or the second sheet and a second portion covering a corresponding portion of the other of the first sheet or the second sheet, wherein the first portion and the second portion are integrally joined with an edge portion that covers a portion of the one or more edges of the base panel, and the one or more edge guards further comprising one or more glide rails that extend from the edge portion.

15. The method of claim 10, wherein cargo restraint panel comprises a hinge, a first magnet, and a magnetic attraction element comprising at least one of a second magnet or a plate, and wherein the first magnet and the magnetic attraction element are positioned so that, when the cargo restraint panel is placed into a folded configuration by folding along the hinge, the first magnet attracts the magnetic attraction element to bias the cargo restraint panel in the folded configuration.

16. A cargo restraint system configured to be used within a cargo container that includes cargo units loaded in the cargo container, the cargo restraint system comprising:
a first load restraint strip comprising a first attachment region affixed to a first interior wall of the cargo container;
a second load restraint strip comprising a second attachment region affixed to a second interior wall of the cargo container; and
a foldable, cargo restraint panel adjacent the cargo units, wherein the cargo restraint panel comprises an extruded base panel formed from a polymer material, the base panel comprising a first sheet integrally joined to a second sheet by corrugations to form a unitary, integral structure of the base panel, wherein the first sheet includes a first major surface facing the loaded cargo units and the second sheet includes a second major surface facing away from the loaded cargo units, wherein the cargo restraint panel further comprises one or more edge guards covering one or more edges of the base panel;
wherein a first tail of the first load restraint strip and a second tail of the second load restraint strip are wrapped across the second major surface, and
wherein the wrapped first tail is secured to the wrapped second tail.

17. The cargo restraint system of claim 16, wherein the base panel comprises a thickness of between 6 and 12 mm.

18. The cargo restraint system of claim 16, wherein the one or more edge guards comprise a first portion covering a region of one of the first sheet or the second sheet and a second portion covering a corresponding portion of the other of the first sheet or the second sheet, wherein the first portion and the second portion are integrally joined with an edge portion that covers a portion of the one or more edges of the base panel, and the one or more edge guards further comprising one or more glide rails that extend from the edge portion.

19. The cargo restraint system of claim 16, wherein cargo restraint panel comprises a hinge, a first magnet, and a magnetic attraction element comprising at least one of a second magnet or a plate, and wherein the first magnet and the magnetic attraction element are positioned so that, when the cargo restraint panel is placed into a folded configuration by folding along the hinge, the first magnet attracts the magnetic attraction element to bias the cargo restraint panel in the folded configuration.

20. The cargo restraint system of claim 16, wherein the base panel is formed from one or more of: polypropylene, acrylonitrile butadiene styrene (ABS), polyvinyl chloride PVC), polyethylene terephthalate (PET), high density polyethylene (HDPE), medium density polyethylene (MDPE), low density polyethylene (LDPE), Nylon, or polycarbonate.
